(19) United States
(12) Patent Application Publication
(10) Pub. No.: US 2010/0265356 A1
(43) Pub. Date: Oct. 21, 2010

(54) Image processing method, image processing apparatus, image capturing appartus and image processing program

(76) Inventors: Hiroaki Takano, Tokyo (JP); Tsukasa Ito, Tokyo (JP); Takeshi Nakajima, Tokyo (JP); Daisuke Sato, Osaka (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/920,708

(22) PCT Filed: Apr. 17, 2006
(86) PCT No.: PCT/JP2006/308012

§ 371 Date: Nov. 16, 2007

(30) Foreign Application Priority Data
May 19, 2005 (JP) 2005-147027

(51) Int. Cl. H04N 9/73

(52) U.S. Cl. 348/223.1; 348/E09.055

(57) ABSTRACT

There is described an image processing method, which makes it possible to continuously and appropriately corrects excessiveness or shortage of light amount in the flesh-color area. The image processing method includes: a light source condition index calculating process for calculating an index representing a light source condition of the captured image data; a correction value calculating process for calculating a correction value of the reproduction target value, corresponding to the index representing the light source condition; a first gradation conversion condition calculating process for calculating a gradation conversion condition for the captured image data, based on the correction value of the reproduction target value; an exposure condition index calculating process for calculating an index representing an exposure condition of the captured image data; and a second gradation conversion condition calculating process for calculating a gradation conversion condition for the captured image data, corresponding to the index representing the exposure condition.

### FIELD OF THE INVENTION

The present invention relates to an image-processing method, an image-processing apparatus, an image capturing apparatus and an image processing program.

### TECHNICAL BACKGROUND

Since a recordable brightness range (Dynamic Range) of a negative film is relatively wide, for instance, it has been possible to obtain a well-finished photographic print even from such a film that is photographed by a relatively low-price camera having no exposure controlling function, by applying a density correction processing to the photographed image in the printing process conducted by a print producing apparatus (Mini Lab.) side. Accordingly, the improvement of the density correction efficiency in the Mini Lab. has been an indispensable factor for providing a low cost camera and a print having a high added value, and various kinds of improvements, such as a digitalization, an automation, etc., have been applied to the Mini Lab.

In recent years, associated with the rapid proliferation of digital cameras, a frequency of occasions for digitally exposing an image represented by the captured image data onto the silver-halide print paper, so as to acquire a photographic print, in the same manner as employing the negative film, has increased as well. Since the dynamic range of the digital camera is extremely narrow compared to that of the negative film, and the recordable brightness range is inherently small, it has been quite difficult to stably acquire the correction effect of the density correction processing. Specifically, an excessive amount of the density correction and/or a variation of the correction amounts have been liable to degrade a quality of the photographic print, and accordingly, it has been desired to improve the maneuverability of the apparatus and the accuracy of the automatic density correction processing.

The automatic density correction processing to be conducted by the Mini Lab can be divided into two main technical elements, namely, “DISCRIMINATION OF PHOTOGRAPHIC CONDITION” and “IMAGE QUALITY CORRECTION PROCESSING”. Hereinafter, the photographic condition is attributed to three factors of a light source, an exposure and a subject at the time of the image capturing operation, while the term of “image quality” represents a gradation characteristic of the photographic print concerned (also referred to as a “tone reproduction”).

With respect to the “DISCRIMINATION OF PHOTOGRAPHIC CONDITION” mentioned in the above, conventionally, various kinds of technical developing activities have been conducted. Conventionally, the brightness correction processing of an image captured by the film scanner or the digital camera (namely, density correction of the photographic print) is achieved by correcting an average brightness value of the whole image, so that the average brightness value shifts to a value desired by the user. Further, in the normal image capturing mode, since the photographic condition, such as a normal light, a backlight, a strobe lighting, etc., varies according to the current situation, and a large area, in which the brightness is extremely biased, is possibly generated in the image concerned, it has been necessary to apply an additional correction processing, which uses values derived from the discriminant analysis and/or the multiple regression analysis, to the image, in addition to the correction processing of the average brightness value. However, there has been a problem that, when employing the discriminant regression analysis mentioned in the above, since a parameter calculated for the strobe light scene is very similar to that calculated for the backlight scene, it is difficult to discriminate the photographic conditions (the light source condition and the exposure condition) from each other.

Patent Document 1 sets forth a calculating method for calculating an additional correction value as a substitute of the discriminant regression analysis. According to the method set forth in Patent Document 1, by employing values derived by deleting a high brightness area and a low brightness area from the brightness histogram indicating a cumulative number of pixels of brightness (frequency number), and further limiting the frequency number, the average value of the brightness is calculated, so as to find the correction value as the differential value between the average value calculated in the above and the reference brightness.

Further, to compensate for the accuracy of extracting an image area of the human face, a method for distihguishing a status of the light source, at the time of the image-capturing operation, is set forth in Patent Document 2. The method set forth in Patent Document 2 includes the steps of: extracting a human face candidate area; calculating the brightness eccentricity amount of the human face candidate area extracted in the previous step; conducting the operation for determining the image capturing condition (whether a backlight condition or a strobe near-lighting condition); and adjusting the allowance range of the determination reference for the human face area. As the method for extracting the human face candidate area, the method, which employs the two dimensional histogram of hue and saturation, set forth in Tokkaihei 6-67320 (Japanese Non-Examined Patent Publication), the pattern matching method and the pattern retrieving method, set forth in Tokkaihei 8-122944, Tokkaihei 8-184925 and Tokkaihei 9-138471, (Japanese Non-Examined Patent Publication), etc. are cited in Patent Document 2.

Still further, as the method for removing a background area other than the human face area, the method for discriminating the background area by employing a ratio of straight line portion, a line symmetry property, a contacting ratio with the outer edge of the image concerned, a density contrast, and a pattern or periodicity of the density change, which are set forth in Tokkaihei 8-122944 and Tokkaihei 8-184925 (Japanese Non-Examined Patent Publication), are cited in Patent Document 2. Still further, as for the determining operation of the photographic condition, the method for employing the one-dimensional histogram of the density is described. This method is based on such an empirical rule that the face area is dark and the background area is bright in the case of the backlight condition, while the face area is bright and the background area is dark in the case of the strobe lighting condition.

[Patent Document 1]
Tokkai 2002-247393, (Japanese Non-Examined Patent Publication)

[Patent Document 2]
Tokkai 2000-148980, (Japanese Non-Examined Patent Publication)

### DISCLOSURE OF THE INVENTION

### Subject to be Solved by the Invention

However, since only the gradation conversion processing condition, which is calculated by the method of either the light source condition or the exposure condition, is applied as the image capturing condition in the abovementioned gradation conversion method, there has been a problem that the density correction effect of the exposure condition (“Under”, “Over”), specifically at the forward lighting, the backward lighting and the low accurate area being an intermediate area between them, is insufficient.

The subject of the present invention is to make such an image processing that continuously and appropriately compensates for (corrects) an excessiveness or shortage of light amount in the flesh-color area, caused by both the light source condition and the exposure condition, possible.

### Means for Solving the Subject

In order to solve the abovementioned problem, the invention, recited in item 1, is characterized in that, in an image processing method for calculating a brightness value indicating brightness in a flesh-color area represented by captured image data, so as to correct the brightness value to a reproduction target value determined in advance, the image processing method includes:

a light source condition index calculating process for calculating an index representing a light source condition of the captured image data;

a correction value calculating process for calculating a correction value of the reproduction target value, corresponding to the index representing the light source condition, calculated in the light source condition index calculating process;

a first gradation conversion condition calculating process for calculating a gradation conversion condition for the captured image data, based on the correction value of the reproduction target value, calculated in the correction value calculating process;

an exposure condition index calculating process for calculating an index representing an exposure condition of the captured image data; and

a second gradation conversion condition calculating process for calculating a gradation conversion condition for the captured image data, corresponding to the index representing the exposure condition, calculated in the exposure condition index calculating process.

The invention, recited in item 2, is characterized in that, in an image processing method for calculating a brightness value indicating brightness in a flesh-color area represented by captured image data, so as to correct the brightness value to a reproduction target value determined in advance, the image processing method includes:

a light source condition index calculating process for calculating an index representing a light source condition of the captured image data;

a correction value calculating process for calculating a correction value of the brightness in the flesh-color area, corresponding to the index representing the light source condition, calculated in the light source condition index calculating process;

a first gradation conversion condition calculating process for calculating a gradation conversion condition for the captured image data, based on the correction value of the brightness, calculated in the correction value calculating process;

an exposure condition index calculating process for calculating an index representing an exposure condition of the captured image data; and

a second gradation conversion condition calculating process for calculating a gradation conversion condition for the captured image data, corresponding to the index representing the exposure condition, calculated in the exposure condition index calculating process.

The invention, recited in item 3, is characterized in that, in an image processing method for calculating a brightness value indicating brightness in a flesh-color area represented by captured image data, so as to correct the brightness value to a reproduction target value determined in advance, the image processing method includes:

a light source condition index calculating process for calculating an index representing a light source condition of the captured image data;

a correction value calculating process for calculating a correction value of the reproduction target value and another correction value of the brightness in the flesh-color area, corresponding to the index representing the light source condition, calculated in the light source condition index calculating process;

a first gradation conversion condition calculating process for calculating a gradation conversion condition for the captured image data, based on the correction value of the reproduction target value and the other correction value of the brightness in the flesh-color area, calculated in the correction value calculating process;

an exposure condition index calculating process for calculating an index representing an exposure condition of the captured image data; and

a second gradation conversion condition calculating process for calculating a gradation conversion condition for the captured image data, corresponding to the index representing the exposure condition, calculated in the exposure condition index calculating process.

The invention, recited in item 4, is characterized in that, in an image processing method for calculating a brightness value indicating brightness in a flesh-color area represented by captured image data, so as to correct the brightness value to a reproduction target value determined in advance, the image processing method includes:

a light source condition index calculating process for calculating an index representing a light source condition of the captured image data;

a correction value calculating process for calculating a correction value of a differential value between the brightness value indicating the brightness in the flesh-color and the reproduction target value, corresponding to the index representing the light source condition, calculated in the light source condition index calculating process;

a first gradation conversion condition calculating process for calculating a gradation conversion condition for the captured image data, based on the correction value of the differential value, calculated in the correction value calculating process;

an exposure condition index calculating process for calculating an index representing an exposure condition of the captured image data; and

a second gradation conversion condition calculating process for calculating a gradation conversion condition for the captured image data, corresponding to the index representing the exposure condition, calculated in the exposure condition index calculating process.

The invention, recited in item 5, is characterized in that, in the image processing method, recited in item 1 or 3, a maximum value and a minimum value of the correction value of the reproduction target value are established in advance, corresponding to the index representing the light source condition.

The invention, recited in item 6, is characterized in that, in the image processing method, recited in item 2 or 3, a maximum value and a minimum value of the correction value of the brightness in a flesh-color area are established in advance, corresponding to the index representing the light source condition.

The invention, recited in item 7, is characterized in that, in the image processing method, recited in item 4, a maximum value and a minimum value of the correction value of the differential value between the brightness value indicating the brightness in the flesh-color and the reproduction target value are established in advance, corresponding to the index representing the light source condition.

The invention, recited in item 8, is characterized in that, in the image processing method, recited in any one of items 5-7, a differential value between the maximum value and the minimum value of the correction value is at least 35 as a value represented by 8-bit value.

The invention, recited in item 9, is characterized in that, in the image processing method, recited in any one of items 1-8, the image processing method is further includes:

a judging process for judging the light source condition of the captured image data, based on the index representing the light source condition calculated in the light source condition index calculating process and a judging map, which is divided into areas corresponding to reliability of the light source condition; and

the correction value is calculated, based on a judging result made in the judging process.

The invention, recited in item 10, is characterized in that, in the image processing method, recited in any one of items 1-9, the image processing method is further includes:

an occupation ratio calculating process for dividing the captured image data into divided areas having combinations of predetermined hue and brightness, and calculating an occupation ratio indicating a ratio of each of the divided areas to a total image area represented by the captured image data is calculated for every area; and,

in the light source condition index calculating process, the index representing the light source condition is calculated by multiplying the occupation ratio calculated in the occupation ratio calculating process by a coefficient established in advance corresponding to the light source condition.

The invention, recited in item 11, is characterized in that, in the image processing method, recited in any one of items 1-9, the image processing method is further includes:

an occupation ratio calculating process for dividing the captured image data into predetermined areas having combinations of distances from an outside edge of an image represented by the captured image data and brightness, and calculating an occupation ratio, indicating a ratio of each of the predetermined areas to a total image area represented by the captured image data, for every divided area concerned; and

the index representing the'light source condition is calculated by multiplying the occupation ratio calculated in the occupation ratio calculating process by a coefficient established in advance corresponding to the light source condition, in the light source condition index calculating process.

The invention, recited in item 12, is characterized in that, in the image processing method, recited in any one of items 1-9, the image processing method is further includes:

an occupation ratio calculating process for dividing the captured image data into divided areas having combinations of predetermined hue and brightness, and calculating a first occupation ratio, indicating a ratio of each of the divided areas to a total image area represented by the captured image data, for every divided area concerned, and at the same time, for dividing the captured image data into predetermined areas having combinations of distances from an outside edge of an image represented by the captured image data and brightness, and calculating a second occupation ratio, indicating a ratio of each of the predetermined areas to a total image area represented by the captured image data, for every divided area concerned; and

the index representing the light source condition is calculated by multiplying the first occupation ratio and the second occupation ratio calculated in the occupation ratio calculating process by a coefficient established in advance corresponding to the light source condition, in the light source condition index calculating process.

The invention, recited in item 13, is characterized in that, in the image processing method, recited in any one of items 1-12, in the second gradation conversion condition calculating process, gradation conversion conditions for the captured image data are calculated, based on the index representing the exposure condition, which is calculated in the exposure condition index calculating process, and a differential value between the brightness value indicating brightness in the flesh-color area and the reproduction target value.

The invention, recited in item 14, is characterized in that, in the image processing method, recited in any one of items 1-12, in the second gradation conversion condition calculating process, gradation conversion conditions for the captured image data are calculated, based on the index representing the exposure condition, which is calculated in the exposure condition index calculating process, and a differential value between another brightness value indicating brightness of a total image area represented by the captured image data and the reproduction target value.

The invention, recited in item 15, is characterized in that, in the image processing method, recited in any one of items 1-14, the image processing method is further includes:

a bias amount calculating process for calculating a bias amount indicating a bias of a gradation distribution of the captured image data; and,

in the exposure condition index calculating process, the index representing the exposure condition is calculated by multiplying the bias amount calculated in the bias amount calculating process by a coefficient established in advance corresponding to the exposure condition.

The invention, recited in item 16, is characterized in that, in the image processing method, recited in item 15, the bias amount includes at least any one of a deviation amount of brightness of the captured image data, an average value of brightness at a central position of an image represented by the captured image data, a differential value between brightness calculated under different conditions.

The invention, recited in item 17, is characterized in that, in the image processing method, recited in item 11 or any one of items 13-16, the image processing method is further includes:

a process for creating a two dimensional histogram by calculating a cumulative number of pixels for every distance from an outside edge of an image represented by the captured image data, and for every brightness; and,

in the occupation ratio calculating process, the occupation ratio is calculated, based on the two dimensional histogram created in the process.

The invention, recited in item 18, is characterized in that, in the image processing method, recited in any one of items 12-16, the image processing method is further includes:

a process for creating a two dimensional histogram by calculating a cumulative number of pixels for every distance from an outside edge of an image represented by the captured image data, and for every brightness; and,

in the occupation ratio calculating process, the second occupation ratio is calculated, based on the two dimensional histogram created in the process.

The invention, recited in item 19, is characterized in that, in the image processing method, recited in item 10 or any one of items 13-16, the image processing method is further includes:

a process for creating a two dimensional histogram by calculating a cumulative number of pixels for every predetermined hue and for every predetermined brightness of the captured image data; and,

in the occupation ratio calculating process, the occupation ratio is calculated, based on the two dimensional histogram created in the process.

The invention, recited in item 20, is characterized in that, in the image processing method, recited in any one of items 12-16, the image processing method is further includes:

a process for creating a two dimensional histogram by calculating a cumulative number of pixels for every predetermined hue and for every predetermined brightness of the captured image data; and,

in the occupation ratio calculating process, the first occupation ratio is calculated, based on the two dimensional histogram created in the process.

The invention, recited in item 21, is characterized in that, in the image processing method, recited in item 10 or any one of items 12-16 or any one of items 18-20, in at least any one of the light source condition index calculating process and the exposure condition index calculating process, a sign of the coefficient to be employed in a flesh-color area having high brightness is different from that of the other coefficient to be employed in a hue area other than the flesh-color area having the high brightness.

The invention, recited in item 22, is characterized in that, in the image processing method, recited in item 10 or any one of items 12-16 or any one of items 18-21, in at least any one of the light source condition index calculating process and the exposure condition index calculating process, a sign of the coefficient to be employed in a flesh-color area having intermediate brightness is different from that of the other coefficient to be employed in a hue area other than the flesh-color area having the intermediate brightness.

The invention, recited in item 23, is characterized in that, in the image processing method, recited in item 21, a brightness area of the hue area other than the flesh-color area having the high brightness is a predetermined high brightness area.

The invention, recited in item 24, is characterized in that, in the image processing method, recited in item 21, a brightness area other than the intermediate brightness area is a brightness area within the flesh-color area.

The invention, recited in item 25, is characterized in that, in the image processing method, recited in item 21 or 23, the flesh-color area having the high brightness includes an area having a brightness value in a range of 170-224 as a brightness value defined by the HSV color specification system.

The invention, recited in item 26, is characterized in that, in the image processing method, recited in item 22 or 24, the intermediate brightness area includes an area having a brightness value in a range of 85-169 as a brightness value defined by the HSV color specification system.

The invention, recited in item 27, is characterized in that, in the image processing method, recited in any one of items 21, 23 and 25, the hue area other than the flesh-color area having the high brightness includes at least any one of a blue hue area and a green hue area.

The invention, recited in item 28, is characterized in that, in the image processing method, recited in any one of items 22, 24 and 26, the hue area other than the flesh-color area having the intermediate brightness is a shadow area.

The invention, recited in item 29, is characterized in that, in the image processing method, recited in item 27, a hue value of the blue hue area is in a range of 161-250 as a hue value defined by the HSV color specification system, while a hue value of the green hue area is in a range of 40-160 as a hue value defined by the HSV color specification system.

The invention, recited in item 30, is characterized in that, in the image processing method, recited in item 28, a brightness value of the shadow area is in a range of 26-84 as a brightness value defined by the HSV color specification system.

The invention, recited in item 31, is characterized in that, in the image processing method, recited in any one of items 21-30, a hue value of the flesh-color area is in a range of 0-39 and a range of 330-359 as a hue value defined by the HSV color specification system.

The invention, recited in item 32, is characterized in that, in the image processing method, recited in any one of items 21-31, the flesh-color area is divided into two areas by employing a predetermined conditional equation based on brightness and saturation.

The invention, recited in item 33, is characterized in that, in an image processing apparatus that calculates a brightness value indicating brightness in a flesh-color area represented by captured image data, so as to correct the brightness value to a reproduction target value determined in advance, the image processing apparatus is provided with:

a light source condition index calculating means for calculating an index representing a light source condition of the captured image data;

a correction value calculating means for calculating a correction value of the reproduction target value, corresponding to the index representing the light source condition, calculated by the light source condition index calculating means;

a first gradation conversion condition calculating means for calculating a gradation conversion condition for the captured image data, based on the correction value of the reproduction target value, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 34, is characterized in that, in an image processing apparatus that calculates a brightness value indicating brightness in a flesh-color area represented by captured image data, so as to correct the brightness value to a reproduction target value determined in advance, the image processing apparatus is provided with:

a light source condition index calculating means for calculating an index representing a light source condition of the captured image data;

a correction value calculating means for calculating a correction value of the brightness in the flesh-color area, corresponding to the index representing the light source condition, calculated by the light source condition index calculating means;

a first gradation conversion condition calculating means for calculating a gradation conversion condition for the captured image data, based on the correction value of the brightness, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 35, is characterized in that, in an image processing apparatus that calculates a brightness value indicating brightness in a flesh-color area represented by captured image data, so as to correct the brightness value to a reproduction target value determined in advance, the image processing apparatus is provided with:

a light source condition index calculating means for calculating an index representing a light source condition of the captured image data;

a correction value calculating means for calculating a correction value of the reproduction target value and another correction value of the brightness in the flesh-color area, corresponding to the index representing the light source condition, calculated by the light source condition index calculating means;

a first gradation conversion condition calculating means for calculating a gradation conversion condition for the captured image data, based on the correction value of the reproduction target value and the other correction value of the brightness in the flesh-color area, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 36, is characterized in that, in an image processing apparatus that calculates a brightness value indicating brightness in a flesh-color area represented by captured image data, so as to correct the brightness value to a reproduction target value determined in advance, the image processing apparatus is provided with:

a light source condition index calculating means for calculating an index representing a light source condition of the captured image data;

a correction value calculating means for calculating a correction value of a differential value between the brightness value indicating the brightness in the flesh-color and the reproduction target value, corresponding to the index representing the light source condition, calculated by the light source condition index calculating means;

a first gradation conversion condition calculating means for calculating a gradation conversion condition for the captured image data, based on the correction value of the differential value, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 37, is characterized in that, in the image processing apparatus, recited in item 33 or 35, a maximum value and a minimum value of the correction value of the reproduction target value are established in advance, corresponding to the index representing the light source condition.

The invention, recited in item 38, is characterized in that, in the image processing apparatus, recited in item 34 or 35, a maximum value and a minimum value of the correction value of the brightness in a flesh-color area are established in advance, corresponding to the index representing the light source condition.

The invention, recited in item 39, is characterized in that, in the image processing apparatus, recited in item 36, characterized in that a maximum value and a minimum value of the correction value of the differential value between the brightness value indicating the brightness in the flesh-color and the reproduction target value are established in advance, corresponding to the index representing the light source condition.

The invention, recited in item 40, is characterized in that, in the image processing apparatus, recited in any one of items 37-39, a differential value between the maximum value and the minimum value of the correction value is at least 35 as a value represented by 8-bit value.

The invention, recited in item 41, is characterized in that, in the image processing apparatus, recited in any one of items 33-40, the image processing apparatus is further provided with:

a judging means for judging the light source condition of the captured image data, based on the index representing the light source condition calculated by the light source condition index calculating means and a judging map, which is divided into areas corresponding to reliability of the light source condition; and

the correction value is calculated, based on a judging result made in the judging means.

The invention, recited in item 42, is characterized in that, in the image processing apparatus, recited in any one of items 33-41, the image processing apparatus is further provided with:

an occupation ratio calculating means for dividing the captured image data into divided areas having combinations of predetermined hue and brightness, and calculating an occupation ratio indicating a ratio of each of the divided areas to a total image area represented by the captured image data is calculated for every area; and

the light source condition index calculating means calculates the index representing the light source condition by multiplying the occupation ratio, calculated by the occupation ratio calculating means, by a coefficient established in advance corresponding to the light source condition.

The invention, recited in item 43, is characterized in that, in the image processing apparatus, recited in any one of items 33-41, the image processing apparatus is further provided with:

an occupation ratio calculating means for dividing the captured image data into predetermined areas having combinations of distances from an outside edge of an image represented by the captured image data and brightness, and calculating an occupation ratio, indicating a ratio of each of the predetermined areas to a total image area represented by the captured image data, for every divided area concerned; and

the light source condition index calculating means calculates the index, representing the light source condition, by multiplying the occupation ratio, calculated by the occupation ratio calculating means, by a coefficient established in advance corresponding to the light source condition.

The invention, recited in item 44, is characterized in that, in the image processing apparatus, recited in any one of items 33-41, the image processing apparatus is further provided with:

an occupation ratio calculating means for dividing the captured image data into divided areas having combinations of predetermined hue and brightness, and calculating an first occupation ratio, indicating a ratio of each of the divided areas to a total image area represented by the captured image data, for every divided area concerned, and at the same time, for dividing the captured image data into predetermined areas having combinations of distances from an outside edge of an image represented by the captured image data and brightness, and calculating an second occupation ratio indicating a ratio of each of the predetermined areas to a total image area represented by the captured image data, for every divided area concerned; and

the index representing the light source condition is calculated by multiplying the first occupation ratio and the second occupation ratio calculated by the occupation ratio calculating means by a coefficient established in advance corresponding to the light source condition, in the light source condition index calculating means.

The invention, recited in item 45, is characterized in that, in the image processing apparatus, recited in any one of items 33-44, the second gradation conversion condition calculating means calculates gradation conversion conditions for the captured image data, based on the index representing the exposure condition, which is calculated by the exposure condition index calculating means, and a differential value between the brightness value, indicating brightness in the flesh-color area, and the reproduction target value.

The invention, recited in item 46, is characterized in that, in the image processing apparatus, recited in any one of items 33-44, the second gradation conversion condition calculating means calculates gradation conversion conditions for the captured image data, based on the index representing the exposure condition, which is calculated by the exposure condition index calculating means, and a differential value between another brightness value indicating brightness of a total image area, represented by the captured image data, and the reproduction target value.

The invention, recited in item 47, is characterized in that, in the image processing apparatus, recited in any one of items 33-46, the image processing apparatus is further provided with:

a bias amount calculating means for calculating a bias amount indicating a bias of a gradation distribution of the captured image data; and

the exposure condition index calculating means calculates the index, representing the exposure condition, by multiplying the bias amount, calculated by the bias amount calculating means, by a coefficient established in advance corresponding to the exposure condition.

The invention, recited in item 48, is characterized in that, in the image processing apparatus, recited in item 47, the bias amount includes at least any one of a deviation amount of brightness of the captured image data, an average value of brightness at a central position of an image represented by the captured image data, a differential value between brightness calculated under different conditions.

The invention, recited in item 49, is characterized in that, in the image processing apparatus, recited in item 43 or any one of items 45-48, the image processing apparatus is further provided with:

a means for creating a two dimensional histogram by calculating a cumulative number of pixels for every distance from an outside edge of an image represented by the captured image data, and for every brightness; and

the occupation ratio calculating means calculates the occupation ratio, based on the two dimensional histogram created by the means.

The invention, recited in item 50, is characterized in that, in the image processing apparatus, recited in any one of items 44-48, the image processing apparatus is further provided with:

a means for creating a two dimensional histogram by calculating a cumulative number of pixels for every distance from an outside edge of an image represented by the captured image data, and for every brightness; and

the occupation ratio calculating means calculates the second occupation ratio, based on the two dimensional histogram created by the means.

The invention, recited in item 51, is characterized in that, in the image processing apparatus, recited in item 42 or any one of items 45-48, the image processing apparatus is further provided with:

a means for creating a two dimensional histogram by calculating a cumulative number of pixels for every predetermined hue and for every predetermined brightness of the captured image data; and

the occupation ratio calculating means calculates the occupation ratio, based on the two dimensional histogram created by the means.

The invention, recited in item 52, is characterized in that, in the image processing apparatus, recited in any one of items 44-48, the image processing apparatus is further provided with:

a means for creating a two dimensional histogram by calculating a cumulative number of pixels for every predetermined hue and for every predetermined brightness of the captured image data; and,

the occupation ratio calculating means calculates the first occupation ratio, based on the two dimensional histogram created by the means.

The invention, recited in item 53, is characterized in that, in the image processing apparatus, recited in item 42 or any one of items 44-48 or any one of items 50-52, at least any one of the light source condition index calculating means and the exposure condition index calculating means employs the coefficient in a flesh-color area having high brightness and the other coefficient in a hue area other than the flesh-color area having the high brightness, signs of which are different from each other.

The invention, recited in item 54, is characterized in that, in the image processing apparatus, recited in item 42 or any one of items 44-48 or any one of items 50-53, at least any one of the light source condition index calculating means and the exposure condition index calculating means employs the coefficient to be employed in a flesh-color area having intermediate brightness and the other coefficient to be employed in a hue area other than the flesh-color area having the intermediate brightness, signs of which are different from each other.

The invention, recited in item 55, is characterized in that, in the image processing apparatus, recited in item 53, a brightness area of the hue area other than the flesh-color area having the high brightness is a predetermined high brightness area.

The invention, recited in item 56, is characterized in that, in the image processing apparatus, recited in item 54, a brightness area other than the intermediate brightness area is a brightness area within the flesh-color area.

The invention, recited in item 57, is characterized in that, in the image processing apparatus, recited in item 53 or 55, the flesh-color area having the high brightness includes an area having a brightness value in a range of 170-224 as a brightness value defined by the HSV color specification system.

The invention, recited in item 58, is characterized in that, in the image processing apparatus, recited in item 54 or 56, the intermediate brightness area includes an area having a brightness value in a range of 85-169 as a brightness value defined by the HSV color specification system.

The invention, recited in item 59, is characterized in that, in the image processing apparatus, recited in any one of items 53, 55 and 57, the hue area other than the flesh-color area having the high brightness includes at least any one of a blue hue area and a green hue area.

The invention, recited in item 60, is characterized in that, in the image processing apparatus, recited in any one of items 54, 56 and 58, the hue area other than the flesh-color area having the intermediate brightness is a shadow area.

The invention, recited in item 61, is characterized in that, in the image processing apparatus, recited in item 59, a hue value of the blue hue area is in a range of 161-250 as a hue value defined by the HSV color specification system, while a hue value of the green hue area is in a range of 40-160 as a hue value defined by the HSV color specification system.

The invention, recited in item 62, is characterized in that, in the image processing apparatus, recited in item 60, a brightness value of the shadow area is in a range of 26-84 as a brightness value defined by the HSV color specification system.

The invention, recited in item 63, is characterized in that, in the image processing apparatus, recited in any one of items 53-62, a hue value of the flesh-color area is in a range of 0-39 and a range of 330-359 as a hue value defined by the HSV color specification system.

The invention, recited in item 64, is characterized in that, in the image processing apparatus, recited in any one of items 53-63, characterized in that the flesh-color area is divided into two areas by employing a predetermined conditional equation based on brightness and saturation.

The invention, recited in item 65, is characterized in that, in an image capturing apparatus that captures a subject to acquire captured image data, and calculates a brightness value indicating brightness in a flesh-color area represented by the captured image data, so as to correct the brightness value to a reproduction target value determined in advance, the image capturing apparatus is provided with:

a light source condition index calculating means for calculating an index representing a light source condition of the captured image data;

a correction value calculating means for calculating a correction value of the reproduction target value, corresponding to the index representing the light source condition, calculated by the light source condition index calculating means;

a first gradation conversion condition calculating means for calculating a gradation conversion condition for the captured image data, based on the correction value of the reproduction target value, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 66, is characterized in that, in an image capturing apparatus that captures a subject to acquire captured image data, and calculates a brightness value indicating brightness in a flesh-color area represented by the captured image data, so as to correct the brightness value to a reproduction target value determined in advance, the image capturing apparatus is provided with:

a light source condition index calculating means for calculating an index representing a light source condition of the captured image data;

a correction value calculating means for calculating a correction value of the brightness in the flesh-color area, corresponding to the index representing the light source condition, calculated by the light source condition index calculating means;

a first gradation conversion condition calculating means for calculating a gradation conversion condition for the captured image data, based on the correction value of the brightness, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 67, is characterized in that, in an image capturing apparatus that captures a subject to acquire captured image data, and calculates a brightness value indicating brightness in a flesh-color area represented by the captured image data, so as to correct the brightness value to a reproduction target value determined in advance, the image capturing apparatus is provided with:

a light source condition index calculating means for calculating an index representing a light source condition of the captured image data;

a correction value calculating means for calculating a correction value of the reproduction target value and another correction value of the brightness in the flesh-color area, corresponding to the index representing the light source condition, calculated by the light source condition index calculating means;

a first gradation conversion condition calculating means for calculating a gradation conversion condition for the captured image data, based on the correction value of the reproduction target value and the other correction value of the brightness in the flesh-color area, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 68, is characterized in that, in an image capturing apparatus that captures a subject to acquire captured image data, and calculates a brightness value indicating brightness in a flesh-color area represented by the captured image data, so as to correct the brightness value to a reproduction target value determined in advance, the image capturing apparatus is provided with:

a light source condition index calculating means for calculating an index representing a light source condition of the captured image data;

a correction value calculating means for calculating a correction value of a differential value between the brightness value indicating the brightness in the flesh-color and the reproduction target value, corresponding to the index representing the light source condition, calculated by the light source condition index calculating means;

a first gradation conversion condition calculating means for calculating a gradation conversion condition for the captured image data, based on the correction value of the differential value, calculated by the correction value calculating means;

an exposure condition index calculating means for calculating an index representing an exposure condition of the captured image data; and

a second gradation conversion condition calculating means for calculating a gradation conversion condition for the captured image data, corresponding to the index representing the exposure condition, calculated by the exposure condition index calculating means.

The invention, recited in item 69, is characterized in that, in the image capturing apparatus, recited in item 65 or 67, a maximum value and a minimum value of the correction value of the reproduction target value are established in advance, corresponding to the index representing the light source condition.

The invention, recited in item 70, is characterized in that, in the image capturing apparatus, recited in item 66 or 67, a maximum value and a minimum value of the correction value of the brightness in a flesh-color area are established in advance, corresponding to the index representing the light source condition.

The invention, recited in item 71, is characterized in that, in the image capturing apparatus, recited in item 68, a maximum value and a minimum value of the correction value of the differential value between the brightness value indicating the brightness in the flesh-color and the reproduction target value are established in advance, corresponding to the index representing the light source condition.

The invention, recited in item 72, is characterized in that, in the image capturing apparatus, recited in any one of items 69-71, a differential value between the maximum value and the minimum value of the correction value is at least 35 as a value represented by 8-bit value.

The invention, recited in item 73, is characterized in that, in the image capturing apparatus, recited in any one of items 65-72, the image capturing apparatus is further provided with:

a judging means for judging the light source condition of the captured image data, based on the index representing the light source condition calculated by the light source condition index calculating means and a judging map, which is divided into areas corresponding to reliability of the light source condition; and

the correction value is calculated, based on a judging result made in the judging means.

The invention, recited in item 74, is characterized in that, in the image capturing apparatus, recited in any one of items 65-73, characterized in that the image capturing apparatus is further provided with:

an occupation ratio calculating means for dividing the captured image data into divided areas having combinations of predetermined hue and brightness, and calculating an occupation ratio indicating a ratio of each of the divided areas to a total image area represented by the captured image data is calculated for every area; and

the light source condition index calculating means calculates the index representing the light source condition by multiplying the occupation ratio, calculated by the occupation ratio calculating means, by a coefficient established in advance corresponding to the light source condition.

The invention, recited in item 75, is characterized in that, in the image capturing apparatus, recited in any one of items 65-73, the image capturing apparatus is further provided with:

an occupation ratio calculating means for dividing the captured image data into predetermined areas having combinations of distances from an outside edge of an image represented by the captured image data and brightness, and calculating an occupation ratio, indicating a ratio of each of the predetermined areas to a total image area represented by the captured image data, for every divided area concerned; and

the light source condition index calculating means calculates the index, representing the light source condition, by multiplying the occupation ratio, calculated by the occupation ratio calculating means, by a coefficient established in advance corresponding to the light source condition.

The invention, recited in item 76, is characterized in that, in the image capturing apparatus, recited in any one of items 65-73, the image capturing apparatus is further provided with:

an occupation ratio calculating means for dividing the captured image data into divided areas having combinations of predetermined hue and brightness, and calculating an first occupation ratio, indicating a ratio of each of the divided areas to a total image area represented by the captured image data, for every divided area concerned, and at the same time, for dividing the captured image data into predetermined areas having combinations of distances from an outside edge of an image represented by the captured image data and brightness, and calculating an second occupation ratio indicating a ratio of each of the predetermined areas to a total image area represented by the captured image data, for every divided area concerned; and

the index representing the light source condition is calculated by multiplying the first occupation ratio and the second occupation ratio calculated by the occupation ratio calculating means by a coefficient established in advance corresponding to the light source condition, in the light source condition index calculating means.

The invention, recited in item 77, is characterized in that, in the image capturing apparatus, recited in any one of items 65-76, the second gradation conversion condition calculating means calculates gradation conversion conditions for the captured image data, based on the index representing the exposure condition, which is calculated by the exposure condition index calculating means, and a differential value between the brightness value, indicating brightness in the flesh-color area, and the reproduction target value.

The invention, recited in item 78, is characterized in that, in the image capturing apparatus, recited in any one of items 65-76, the second gradation conversion condition calculating means calculates gradation conversion conditions for the captured image data, based on the index representing the exposure condition, which is calculated by the exposure condition index calculating means, and a differential value between another brightness value indicating brightness of a total image area, represented by the captured image data, and the reproduction target value.

The invention, recited in item 79, is characterized in that, in the image capturing apparatus, recited in any one of items 65-78, the image capturing apparatus is further provided with:

a bias amount calculating means for calculating a bias amount indicating a bias of a gradation distribution of the captured image data; and

the exposure condition index calculating means calculates the index, representing the exposure condition, by multiplying the bias amount, calculated by the bias amount calculating means, by a coefficient established in advance corresponding to the exposure condition.

The invention, recited in item 80, is characterized in that, in the image capturing apparatus, recited in item 79, the bias amount includes at least any one of a deviation amount of brightness of the captured image data, an average value of brightness at a central position of an image represented by the captured image data, a differential value between brightness calculated under different conditions.

The invention, recited in item 81, is characterized in that, in the image capturing apparatus, recited in item 75 or any one of items 77-80, the image capturing apparatus is further provided with:

a means for creating a two dimensional histogram by calculating a cumulative number of pixels for every distance from an outside edge of an image represented by the captured image data, and for every brightness; and

the occupation ratio calculating means calculates the occupation ratio, based on the two dimensional histogram created by the means.

The invention, recited in item 82, is characterized in that, in the image capturing apparatus, recited in any one of items 76-80, the image capturing apparatus is further provided with:

a means for creating a two dimensional histogram by calculating a cumulative number of pixels for every distance from an outside edge of an image represented by the captured image data, and for every brightness; and

the occupation ratio calculating means calculates the second occupation ratio, based on the two dimensional histogram created by the means.

The invention, recited in item 83, is characterized in that, in the image capturing apparatus, recited in item 74 or any one of items 77-80, the image capturing apparatus is further provided with:

a means for creating a two dimensional histogram by calculating a cumulative number of pixels for every predetermined hue and for every predetermined brightness of the captured image data; and

the occupation ratio calculating means calculates the occupation ratio, based on the two dimensional histogram created by the means.

The invention, recited in item 84, is characterized in that, in the image capturing apparatus, recited in any one of items 76-80, characterized in that the image capturing apparatus is further provided with:

a means for creating a two dimensional histogram by calculating a cumulative number of pixels for every predetermined hue and for every predetermined brightness of the captured image data; and,

the occupation ratio calculating means calculates the first occupation ratio, based on the two dimensional histogram created by the means.

The invention, recited in item 85, is characterized in that, in the image capturing apparatus, recited in item 74 or any one of items 76-80 or any one of items 82-84, at least any one of the light source condition index calculating means and the exposure condition index calculating means employs the coefficient in a flesh-color area having high brightness and the other coefficient in a hue area other than the flesh-color area having the high brightness, signs of which are different from each other.

The invention, recited in item 86, is characterized in that, in the image capturing apparatus, recited in item 74 or any one of items 76-80 or any one of items 82-85, at least any one of the light source condition index calculating means and the exposure condition index calculating means employs the coefficient to be employed in a flesh-color area having intermediate brightness and the other coefficient to be employed in a hue area other than the flesh-color area having the intermediate brightness, signs of which are different from each other.

The invention, recited in item 87, is characterized in that, in the image capturing apparatus, recited in item 85, characterized in that a brightness area of the hue area other than the flesh-color area having the high brightness is a predetermined high brightness area.

The invention, recited in item 88, is characterized in that, in the image capturing apparatus, recited in item 86, characterized in that a brightness area other than the intermediate brightness area is a brightness area within the flesh-color area.

The invention, recited in item 89, is characterized in that, in the image capturing apparatus, recited in item 85 or 87, the flesh-color area having the high brightness includes an area having a brightness value in a range of 170-224 as a brightness value defined by the HSV color specification system.

The invention, recited in item 90, is characterized in that, in the image capturing apparatus, recited in item 86 or 88, the intermediate brightness area includes an area having a brightness value in a range of 85-169 as a brightness value defined by the HSV color specification system.

The invention, recited in item 91, is characterized in that, in the image capturing apparatus, recited in any one of items 85, 87 and 89, characterized in that the hue area other than the flesh-color area having the high brightness includes at least any one of a blue hue area and a green hue area.

The invention, recited in item 92, is characterized in that, in the image capturing apparatus, recited in any one of items 86, 88 and 90, the hue area other than the flesh-color area having the intermediate brightness is a shadow area.

The invention, recited in item 93, is characterized in that, in the image capturing apparatus, recited in item 91, a hue value of the blue hue area is in a range of 161-250 as a hue value defined by the HSV color specification system, while a hue value of the green hue area is in a range of 40-160 as a hue value defined by the HSV color specification system.

The invention, recited in item 94, is characterized in that, in the image capturing apparatus, recited in item 92, a brightness value of the shadow area is in a range of 26-84 as a brightness value defined by the HSV color specification system.

The invention, recited in item 95, is characterized in that, in the image capturing apparatus, recited in any one of items 85-94, a hue value of the flesh-color area is in a range of 0-39 and a range of 330-359 as a hue value defined by the HSV color specification system.

The invention, recited in item 96, is characterized in that, in the image capturing apparatus, recited in any one of items 85-95, the flesh-color area is divided into two areas by employing a predetermined conditional equation based on brightness and saturation.

The invention, recited in item 97, is an image processing program that makes a computer for implementing image processing realize:

a calculating function for calculating a brightness value indicating brightness in a flesh-color area represented by captured image data;

a light source condition index calculating function for calculating an index representing a light source condition of the captured image data;

a correction value calculating function for calculating a correction value of a reproduction target value determined in advance, corresponding to the index representing the light source condition, when correcting the brightness value indicating brightness in the flesh-color area to the reproduction target value;

a first gradation conversion condition calculating function for calculating a gradation conversion condition for the captured image data, based on the correction value of the reproduction target value, calculated by the correction value calculating function;

an exposure condition index calculating function for calculating an index representing an exposure condition of the captured image data; and

a second gradation conversion condition calculating function for calculating a gradation conversion condition for the captured image data, corresponding to the index representing the exposure condition, calculated in the exposure condition index calculating function.

The invention, recited in item 98, is an image processing program that makes a computer for implementing image processing realize:

a calculating function for calculating a brightness value indicating brightness in a flesh-color area represented by captured image data;

a light source condition index calculating function for calculating an index representing a light source condition of the captured image data;

a correction value calculating function for calculating a correction value of the brightness in the flesh-color area, corresponding to the index representing the light source condition, when correcting the brightness value indicating brightness in the flesh-color area to a reproduction target value determined in advance;

a first gradation conversion condition calculating function for calculating a gradation conversion condition for the captured image data, based on the correction value of the brightness value indicating brightness in the flesh-color area, calculated by the correction value calculating function;

an exposure condition index calculating function for calculating an index representing an exposure condition of the captured image data; and

a second gradation conversion condition calculating function for calculating a gradation conversion condition for the captured image data, corresponding to the index representing the exposure condition, calculated in the exposure condition index calculating function.

The invention, recited in item 99, is an image processing program that makes a computer for implementing image processing realize:

a calculating function for calculating a brightness value indicating brightness in a flesh-color area represented by captured image data;

a light source condition index calculating function for calculating an index representing a light source condition of the captured image data;

a correction value calculating function for calculating a correction value of a reproduction target value determined in advance and another correction value of the brightness in the flesh-color area, corresponding to the index representing the light source condition, when correcting the brightness value indicating brightness in the flesh-color area to the reproduction target value;

a first gradation conversion condition calculating function for calculating a gradation conversion condition for the captured image data, based on the correction value of the reproduction target value and the correction value of the brightness value indicating brightness in the flesh-color area, calculated by the correction value calculating function;

an exposure condition index calculating function for calculating an index representing an exposure condition of the captured image data; and

a second gradation conversion condition calculating function for calculating a gradation conversion condition for the captured image data, corresponding to the index representing the exposure condition, calculated in the exposure condition index calculating function.

The invention, recited in item 100, is an image processing program that makes a computer for implementing image processing realize:

a calculating function for calculating a brightness value indicating brightness in a flesh-color area represented by captured image data;

a light source condition index calculating function for calculating an index representing a light source condition of the captured image data;

a correction value calculating function for calculating a correction value of a differential value between the brightness value indicating the brightness in the flesh-color and a reproduction target value determined in advance, when correcting the brightness value indicating brightness in the flesh-color area to the reproduction target value;

a first gradation conversion condition calculating function for calculating a gradation conversion condition for the captured image data, based on the correction value calculated by the correction value calculating function;

an exposure condition index calculating function for calculating an index representing an exposure condition of the captured image data; and

a second gradation conversion condition calculating function for calculating a gradation conversion condition for the captured image data, corresponding to the index representing the exposure condition, calculated in the exposure condition index calculating function.

The invention, recited in item 101, is characterized in that in the image processing program, recited in item 97 or 99, a maximum value and a minimum value of the correction value of the reproduction target value are established in advance, corresponding to the index representing the light source condition.

The invention, recited in item 102, is characterized in that in the image processing program, recited in item 98 or 99, characterized in that a maximum value and a minimum value of the correction value of the brightness in a flesh-color area are established in advance, corresponding to the index representing the light source condition.

The invention, recited in item 103, is characterized in that in the image processing program, recited in item 100, a maximum value and a minimum value of the correction value of the differential value between the brightness value indicating the brightness in the flesh-color and the reproduction target value are established in advance, corresponding to the index representing the light source condition.

The invention, recited in item 104, is characterized in that in the image processing program, recited in any one of items 101-103, a differential value between the maximum value and the minimum value of the correction value is at least 35 as a value represented by 8-bit value.

The invention, recited in item 105, is characterized in that in the image processing program, recited in any one of items 97-104, the image processing program is further provided with:

a judging function for judging the light source condition of the captured image data, based on the index representing the light source condition calculated in the light source condition index calculating function and a judging map, which is divided into areas corresponding to reliability of the light source condition; and

the correction value is calculated, based on a judging result made by the judging function, when realizing the correction value calculating function.

The invention, recited in item 106, is characterized in that in the image processing program, recited in any one of items 97-105, the image processing program is further provided with:

an occupation ratio calculating function for dividing the captured image data into divided areas having combinations of predetermined hue and brightness, and calculating an occupation ratio indicating a ratio of each of the divided areas to a total image area represented by the captured image data is calculated for every area; and,

when realizing the light source condition index calculating function, the index representing the light source condition is calculated by multiplying the occupation ratio calculated in the occupation ratio calculating function by a coefficient established in advance corresponding to the light source condition.

The invention, recited in item 107, is characterized in that in the image processing program, recited in any one of items 97-105, the image processing program is further provided with:

an occupation ratio calculating function for dividing the captured image data into predetermined areas having combinations of distances from an outside edge of an image represented by the captured image data and brightness, and calculating an occupation ratio, indicating a ratio of each of the predetermined areas to a total image area represented by the captured image data, for every divided area concerned; and

when realizing the the light source condition index calculating function, the index representing the light source condition is calculated by multiplying the occupation ratio calculated in the occupation ratio calculating function by a coefficient established in advance corresponding to the light source condition.

The invention, recited in item 108, is characterized in that in the image processing program, recited in any one of items 97-105, the image processing program is further provided with:

an occupation ratio calculating function for dividing the captured image data into divided areas having combinations of predetermined hue and brightness, and calculating a first occupation ratio, indicating a ratio of each of the divided areas to a total image area represented by the captured image data, for every divided area concerned, and at the same time, for dividing the captured image data into predetermined areas having combinations of distances from an outside edge of an image represented by the captured image data and brightness, and calculating a second occupation ratio, indicating a ratio of each of the predetermined areas to a total image area represented by the captured image data, for every divided area concerned; and

when realizing the light source condition index calculating function, the index representing the light source condition is calculated by multiplying the first occupation ratio and the second occupation ratio calculated in the occupation ratio calculating function by a coefficient established in advance corresponding to the light source condition, in the.

The invention, recited in item 109, is characterized in that in the image processing program, recited in any one of items 97-108, when realizing the second gradation conversion condition calculating function, gradation conversion conditions for the captured image data are calculated, based on the index representing the exposure condition, which is calculated in the exposure condition index calculating function, and a differential value between the brightness value indicating brightness in the flesh-color area and the reproduction target value.

The invention, recited in item 110, is characterized in that in the image processing program, recited in any one of items 97-108, when realizing the second gradation conversion condition calculating function, gradation conversion conditions for the captured image data are calculated, based on the index representing the exposure condition, which is calculated in the exposure condition index calculating function, and a differential value between another brightness value indicating brightness of a total image area represented by the captured image data and the reproduction target value.

The invention, recited in item 111, is characterized in that in the image processing program, recited in any one of items 97-110, the image processing program is further provided with:

a bias amount calculating function for calculating a bias amount indicating a bias of a gradation distribution of the captured image data; and,

when realizing the exposure condition index calculating function, the index representing the exposure condition is calculated by multiplying the bias amount calculated in the bias amount calculating function by a coefficient established in advance corresponding to the exposure condition.

The invention, recited in item 112, is characterized in that in the image processing program, recited in item 111, the bias amount includes at least any one of a deviation amount of brightness of the captured image data, an average value of brightness at a central position of an image represented by the captured image data, a differential value between brightness calculated under different conditions.

The invention, recited in item 113, is characterized in that in the image processing program, recited in item 107 or any one of items 109-112, the image processing program is further provided with:

a function for creating a two dimensional histogram by calculating a cumulative number of pixels for every distance from an outside edge of an image represented by the captured image data, and for every brightness; and,

when realizing the occupation ratio calculating function, the occupation ratio is calculated, based on the two dimensional histogram created in the function.

The invention, recited in item 114, is characterized in that in the image processing program, recited in any one of items 108-112, the image processing program is further provided with:

a function for creating a two dimensional histogram by calculating a cumulative number of pixels for every distance from an outside edge of an image represented by the captured image data, and for every brightness; and,

when realizing the occupation ratio calculating function, the second occupation ratio is calculated, based on the two dimensional histogram created in the function.

The invention, recited in item 115, is characterized in that in the image processing program, recited in item 106 or any one of items 109-112, processing program is further provided with:

a function for creating a two dimensional histogram by calculating a cumulative number of pixels for every predetermined hue and for every predetermined brightness of the captured image data; and,

when realizing the occupation ratio calculating function, the occupation ratio is calculated, based on the two dimensional histogram created in the function.

The invention, recited in item 116, is characterized in that in the image processing program, recited in any one of items 108-112, the image processing program is further provided with:

a function for creating a two dimensional histogram by calculating a cumulative number of pixels for every predetermined hue and for every predetermined brightness of the captured image data; and,

when realizing the occupation ratio calculating function, the first occupation ratio is calculated, based on the two dimensional histogram created in the function.

The invention, recited in item 117, is characterized in that in the image processing program, recited in item 10 or any one of items 12-16 or any one of items 18-20, when realizing at least any one of the light source condition index calculating function and the exposure condition index calculating function, a sign of the coefficient to be employed in a flesh-color area having high brightness is different from that of the other coefficient to be employed in a hue area other than the flesh-color area having the high brightness.

The invention, recited in item 118, is characterized in that in the image processing program, recited in item 106 or any one of items 108-112 or any one of items 114-117, when realizing at least any one of the light source condition index calculating function and the exposure condition index calculating function, a sign of the coefficient to be employed in a flesh-color area having intermediate brightness is different from that of the other coefficient to be employed in a hue area other than the flesh-color area having the intermediate brightness.

The invention, recited in item 119, is characterized in that in the image processing program, recited in item 117, a brightness area of the hue area other than the flesh-color area having the high brightness is a predetermined high brightness area.

The invention, recited in item 120, is characterized in that in the image processing program, recited in item 118, a brightness area other than the intermediate brightness area is a brightness area within the flesh-color area.

The invention, recited in item 121, is characterized in that in the image processing program, recited in item 117 or 119, characterized in that the flesh-color area having the high brightness includes an area having a brightness value in a range of 170-224 as a brightness value defined by the HSV color specification system.

The invention, recited in item 122, is characterized in that in the image processing program, recited in item 118 or 120, the intermediate brightness area includes an area having a brightness value in a range of 85-169 as a brightness value defined by the HSV color specification system.

The invention, recited in item 123, is characterized in that in the image processing program, recited in any one of items 117, 119 and 121, the hue area other than the flesh-color area having the high brightness includes at least any one of a blue hue area and a green hue area.

The invention, recited in item 124, is characterized in that in the image processing program, recited in any one of items 118, 120 and 122, characterized in that the hue area other than the flesh-color area having the intermediate brightness is a shadow area.

The invention, recited in item 125, is characterized in that in the image processing program, recited in item 123, a hue value of the blue hue area is in a range of 161-250 as a hue value defined by the HSV color specification system, while a hue value of the green hue area is in a range of 40-160 as a hue value defined by the HSV color specification system.

The invention, recited in item 126, is characterized in that in the image processing program, recited in item 124, characterized in that a brightness value of the shadow area is in a range of 26-84 as a brightness value defined by the HSV color specification system.

The invention, recited in item 127, is characterized in that in the image processing program, recited in any one of items 117-126, a hue value of the flesh-color area is in a range of 0-39 and a range of 330-359 as a hue value defined by the HSV color specification system.

The invention, recited in item 128, is characterized in that in the image processing program, recited in any one of items 117-127, the flesh-color area is divided into two areas by employing a predetermined conditional equation based on brightness and saturation.

### Effect of the Invention

According to present invention, it becomes possible to conduct such the image processing that continuously and appropriately compensates for (corrects) an excessiveness or shortage of light amount in the flesh-color area, caused by both the light source condition and the exposure condition.

Specifically, since it is possible to apply the gradation conversion processing to the captured image data by employing not only the index representing the light source condition, but also the gradation conversion conditions, which are calculated by employing the index representing the exposure condition, it becomes possible to improve a reliability of the correction concerned.

### BRIEF DESCRIPTION OF THE DRAWINGS

FIG. 1 shows a perspective view of an outlook structure of an image processing apparatus embodied in the present invention.

FIG. 2 shows a block diagram of a internal configuration of an image processing apparatus embodied in the present invention.

FIG. 3 shows an internal configuration of the image processing section 70.

FIG. 4(a) shows a block diagram of an internal configuration of a scene determining section; FIG. 4(b) shows a block diagram of an internal configuration of a ratio calculating section; and FIG. 4(c) shows a block diagram of an internal configuration of a gradation processing condition calculating section.

FIG. 5 shows a flowchart indicating a processing flow to be conducted in an image adjustment processing section.

FIG. 6 shows a flowchart indicating a index calculating processing to be conducted in a scene judging section.

FIG. 7 shows a flowchart indicating a occupation ratio calculation processing for calculating a first occupation ratio for every brightness and hue area.

FIG. 8 shows an exemplary program for converting RGB values to values of the HSV color specification system.

FIG. 9 shows a brightness (V)-hue (H) plane, an area r1 and an area r2 on the V-H plane.

FIG. 10 shows a brightness (V)-hue (H) plane, an area r3 and an area r4 on the V-H plane.

FIG. 11 shows a graph indicating a curvature representing a first coefficient by which a first occupation ratio is multiplied to calculate an index 1.

FIG. 12 shows a graph indicating a curvature representing a second coefficient by which a first occupation ratio is multiplied to calculate an index 2.

FIG. 13 shows a flowchart indicating a second occupation ratio calculation processing for calculating a second occupation ratio based on a compositional image represented by captured image data.

FIG. 14(a), FIG. 14(b), FIG. 14(c), and FIG. 14(d) show four areas n1, n2, n3 and n4, which are divided corresponding to the distances from an outside edge of an image represented by captured image data, respectively.

FIG. 15 shows a graph indicating third coefficients in image areas n1-n4 as curved lines (coefficient curves).

FIG. 16 shows a flowchart indicating a bias amount calculation processing to be performed in a deviation calculating section.

FIG. 17 shows a flowchart indicating a gradation processing condition determining processing to be performed in a gradation processing condition calculating section.

FIG. 18(a) shows a graph on which values of indexes 4 and indexes 5 are plotted, while FIG. 18(b) shows a graph on which values of indexes 4 and indexes 6 are plotted.

FIG. 19(a), FIG. 19(b) and FIG. 19(c) show judging maps for judging image capturing conditions.

FIG. 20 shows a block diagram indicating relationships between indexes for specifying an image capturing condition, parameters A-C and gradation adjusting methods A-C.

FIG. 21(a), FIG. 21(b) and FIG. 21(c) show gradation conversion curves corresponding to each of gradation adjusting methods.

FIG. 22(a) shows a histogram of luminance; FIG. 22(b) shows a normalized histogram of luminance; and FIG. 22(c) shows a histogram divided into blocks.

FIG. 23(a) and FIG. 23(b) show explanatory histograms for explaining an operation for deleting a low luminance area and a high luminance area from a luminance histogram, while FIG. 23(c) and FIG. 23(d) show explanatory histograms for explaining an operation for restricting frequency of luminance.

FIG. 24 shows a flowchart indicating a gradation conversion condition calculation processing to be employed in an embodiment 1.

FIG. 25 shows a flowchart indicating a gradation conversion condition calculation processing to be employed in an embodiment 2.

FIG. 26 shows a flowchart indicating a gradation conversion condition calculation processing to be employed in an embodiment 3.

FIG. 27 shows a flowchart indicating a gradation conversion condition calculation processing to be employed in an embodiment 4.

FIG. 28 shows a graph and a table indicting relationships between indexes and correction values Δ of parameters (reproduction target value, average flesh-color luminance value) to be employed in a gradation conversion condition calculation processing.

FIG. 29 shows a graph indicating gradation conversion curves representing gradation processing conditions, when an image capturing condition is a backward lighting or a strobe “Under” lighting.

FIG. 30 shows a configuration of a digital still camera, to which an image capturing apparatus embodied in the present invention is applied.

### EXPLANATION OF NOTATIONS

1 an image processing apparatus
2 a housing body
3 a magazine loading section
4 an exposure processing section
5 a print creating section
7 a control section*
8 a CRT
9 a film scanning section
10 a reflected document input section
11 an operating section
12 an information inputting means
14 an image reading section
15 an image writing section
30 an image transferring means
31 an image conveying section
32 a communicating section (input)
33 a communicating section (output)
51 an external printer
70 an image processing section
72 a template storage
701 an image adjustment processing section
702 a film scan data processing section
703 a reflective document scan data processing section
704 an image data form decoding processing section
705 a template processing section
706 a CRT inherent processing section
707 a printer inherent processing section A
708 a printer inherent processing section B
709 an image data form creation processing section
710 a scene determining section
711 a gradation converting section
712 a ratio calculating section
713 an index calculating section
714 a gradation processing condition calculating section
715 a color specification system converting section
716 a histogram creating section
717 an occupation ratio calculating section
718 a scene judging section
719 a gradation adjusting method determining section
720 a gradation adjustment parameter calculating section
721 a gradation adjustment amount calculating section
722 a deviation calculating section
200 a digital still camera
208 an image processing section

### BEST MODE FOR IMPLEMENTING THE INVENTION

### First Embodiment

Referring to the drawings, the first embodiment of the present invention will be detailed in the following. Initially, the configuration of the first embodiment will be detailed in the following.

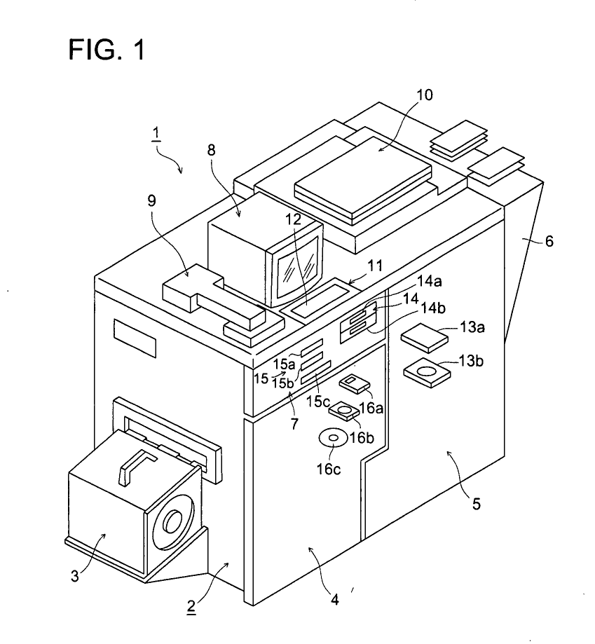

FIG. 1 shows a perspective view of the outlook structure of an image processing apparatus 1 embodied in the present invention. As shown in FIG. 1, the image processing apparatus 1 is provided with a magazine loading section 3 mounted on a side of a housing body 2, an exposure processing section 4, for exposing a photosensitive material, mounted inside the housing body 2 and a print creating section 5 for creating a print. Further, a tray 6 for receiving ejected prints is installed on another side of the housing body 2.

Still further, a CRT 8 (Cathode Ray Tube 8) serving as a display device, a film scanning section 9 serving as a device for reading a transparent document, a reflected document input section 10 and an operating section 11 are provided on the upper side of the housing body 2. The CRT 8 serves as the display device for displaying the image represented by the image information to be created as the print. Further, the image reading section 14 capable of reading image information recorded in various kinds of digital recording mediums and the image writing section 15 capable of writing (outputting) image signals onto various kinds of digital recording mediums are provided in the housing body 2. Still further, a control section 7 for centrally controlling the abovementioned sections is also provided in the housing body 2.

The image reading section 14 is provided with a PC card adaptor 14a, a floppy (Registered Trade Mark) disc adaptor 14b, into each of which a PC card 13a and a floppy disc 13b can be respectively inserted. For instance, the PC card 13a has storage for storing the information with respect to a plurality of frame images captured by the digital still camera. Further, for instance, a plurality of frame images captured by the digital still camera are stored in the floppy (Registered Trade Mark) disc 13b. Other than the PC card 13a and the floppy (Registered Trade Mark) disc 13b, a multimedia card (Registered Trade Mark), a memory stick (Registered Trade Mark), MD data, CD-ROM, etc., can be cited as recording media in which frame image data can be stored.

An image writing section 15 is provided with a floppy (Registered Trade Mark) disk adaptor 15a, a MO adaptor 15b and an optical disk adaptor 15c, into each of which a floppy (Registered Trade Mark) disc 16a, a MO 16b and an optical disc 16c can be respectively inserted. Further, a CD-R, a DVD-R, etc. can be cited as optical disc 16c.

Incidentally, although, in the configuration shown in FIG. 1, the operating section 11, the CRT 8, the film scanning section 9, the reflected document input section 10 and the image reading section 14 are integrally provided in the housing body 2, it is also applicable that one or more of them is separately disposed outside the housing body 2.

Further, although the image processing apparatus 1, which creates a print by exposing/developing the photosensitive material, is exemplified in FIG. 1, the scope of the print creating method in the present invention is not limited to the above, but an apparatus employing any kind of methods, including, for instance, an ink-jetting method, an electro-photographic method, a heat-sensitive method and a sublimation method, is also applicable in the present invention.

### <Configuration of Main Section of Image Processing Apparatus 1>

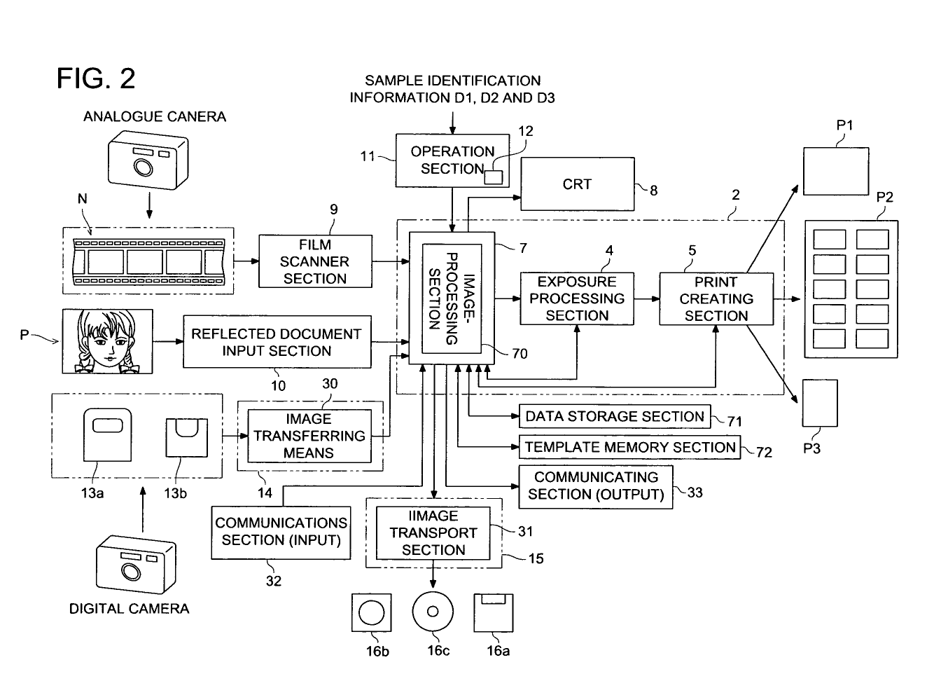

FIG. 2 shows a block diagram of the configuration of main section of the image processing apparatus 1. As shown in FIG. 2, the image processing apparatus 1 is constituted by a control section 7, the exposure processing section 4, the film scanning section 9, the reflected document input section 10, the image reading section 14, a communicating section 32 (input), the image writing section 15, a Data storage section 71, a template memory section 72, the operation section 11, the CRT 8 and a communicating section 33 (output).

The control section 7 includes a microcomputer to control the various sections constituting the image processing apparatus 1 by cooperative operations of a CPU (Central Processing Unit) (not shown in the drawings) and various kinds of controlling programs, including an image-processing program, etc., stored in a storage section (not shown in the drawings), such as ROM (Read Only Memory), etc.

Further, the control section 7 is provided with an image-processing section 70, relating to the image-processing apparatus embodied in the present invention, which applies the image processing of the present invention to image data acquired from the film scanning section 9 and the reflected document input section 10, image data read from the image reading section 14 and image data inputted from an external device through a communicating section 32 (input), based on the input signals (command information) sent from the operating section 11, to generate the image information of exposing use, which are outputted to the exposure processing section 4. Further, image-processing section 70 applies the conversion processing corresponding to its output mode to the processed image data, so as to output the converted image data. The image-processing section 70 outputs the converted image data to the CRT 8, the image writing section 15, the communicating section 33 (output), etc.

The exposure processing section 4 exposes the photosensitive material based on the image signals, and outputs the photosensitive material to the print creating section 5. In the print creating section 5, the exposed photosensitive material is developed and dried to create the prints P1, P2, P3. Incidentally, the prints P1 include service size prints, high-vision size prints, panorama size prints, etc., the prints P2 include A4-size prints, and the prints P3 include visiting card size prints.

The film scanning section 9 reads the frame image data from developed negative film N acquired by developing the negative film having an image captured by an analogue camera. The reflected document input section 10 reads the frame image data from the print P (such as photographic prints, paintings and calligraphic works, various kinds of printed materials) made of a photographic printing paper on which the frame image is exposed and developed, by means of the flat bed scanner.

The image reading section 14 reads the frame image information stored in the PC card 13a and the floppy (Registered Trade Mark) disc 13b to transfer the acquired image information to the control section 7. Further, the image reading section 14 is provided with the PC card adaptor 14a, the floppy disc adaptor 14b serving as an image transferring means 30. Still further, the image reading section 14 reads the frame image information stored in the PC card 13a inserted into the PC card adaptor 14a and the floppy disc 13b inserted into the floppy disc adaptor 14b to transfer the acquired image information to the control section 7. For instance, the PC card reader or the PC card slot, etc. can be employed as the PC card adaptor 14a.

The communicating section 32 (input) receives image signals representing the captured image and print command signals sent from a separate computer located within the site in which the image processing apparatus 1 is installed and/or from a computer located in a remote site through Internet, etc.

The image writing section 15 is provided with the floppy disk adaptor 15a, the MO adaptor 15b and the optical disk adaptor 15c, serving as an image conveying section 31. Further, according to the writing signals inputted from the control section 7, the image writing section 15 writes the data, generated by the image-processing method embodied in the present invention, into the floppy disk 16a inserted into the floppy disk adaptor 15a, the MO disc 16b inserted into the MO adaptor 15b and the optical disk 16c inserted into the optical disk adaptor 15c.

The data storage section 71 stores the image information and its corresponding order information (including information of a number of prints and a frame to be printed, information of print size, etc.) to sequentially accumulate them in it.

The template memory section 72 memorizes the sample image data (data showing the background image and illustrated image) corresponding to the types of information on sample identification D1, D2 and D3, and memorizes at least one of the data items on the template for setting the composite area with the sample image data. When a predetermined template is selected from among multiple templates previously memorized in the template memory section 72 by the operation of the operator, the selected template is merged with the frame image information. Then, the sample image data, selected on the basis of designated sample identification information D1, D2 and D3, are merged with image data and/or character data ordered by a client, so as to create a print based on the designated sample image. This merging operation by this template is performed by the widely known chromakey technique.

The types of information on sample identification D1, D2 and D3 for specifying the print sample are arranged to be inputted from the operation section 11. Since the types of information on sample identification D1, D2 and D3 are recorded on the sample or order sheet, they can be read by the reading section such as an OCR. Alternatively, they can be inputted by the operator through a keyboard.

As described above, sample image data is recorded in response to the sample identification information D1 for specifying the print sample, and the sample identification information D1 for specifying the print sample is inputted. Based on the inputted sample identification information D1, sample image data is selected, and the selected sample image data and image data and/or character data based on the order are merged to create a print according to the specified sample. This procedure allows a user to directly check full-sized samples of various dimensions before placing an order. This permits wide-ranging user requirements to be satisfied.

The first sample identification information D2 for specifying the first sample, and first sample image data are memorized; alternatively, the second sample identification information D3 for specifying the second sample, and second sample image data are memorized. The sample image data selected on the basis of the specified first and second sample identification information D2 and D3, and ordered image data and/or character data are merged with each other, and a print is created according to the specified sample. This procedure allows a greater variety of images to be created, and permits wide-ranging user requirements to be satisfied.

The operating section 11 is provided with an information inputting means 12. The information inputting means 12 is constituted by a touch panel, etc., so as to output a push-down signal generated in the information inputting means 12 to the control section 7 as an inputting signal. Incidentally, it is also applicable that the operating section 11 is provided with a keyboard, a mouse, etc. Further, the CRT 8 displays image information, etc., according to the display controlling signals inputted from the control section 7.

The communicating section 33 (output) transmits the output image signals, representing the captured image and processed by the image-processing method embodied in the present invention, and its corresponding order information to a separate computer located within the site in which the image processing apparatus 1 is installed and/or to a computer located in a remote site through Internet, etc.

As shown in FIG. 2, the image processing apparatus 1 is provided with: an input section for capturing the digital image data of various types and image information obtained by dividing the image document and measuring a property of light; an image processing section; an image outputting section for displaying or printing out the processed image on the image recording medium; and a communications section (output) for sending the image data and accompanying order information to another computer in the facilities through a communications line or a remote computer through Internet, etc.

### <Internal Configuration of Image Processing Section 70>

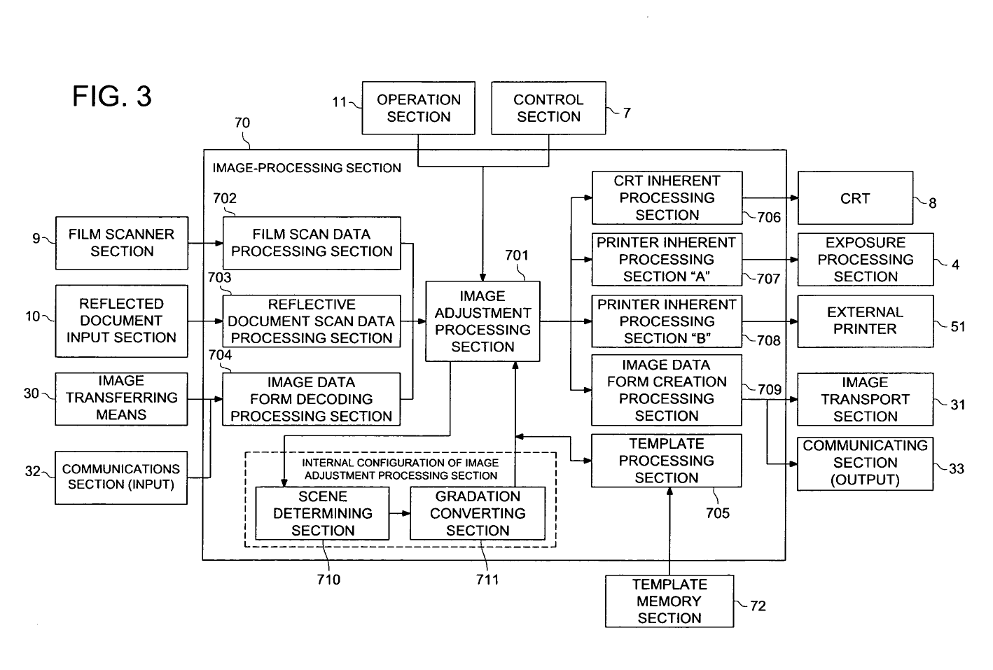

FIG. 3 shows an internal configuration of the image processing section 70. As shown in FIG. 3, the image processing section 70 is provided with an image adjustment processing section 701, a film scan data processing section 702, a reflective document scan data processing section 703, an image data form decoding processing section 704, a template processing section 705, a CRT inherent processing section 706, a printer inherent processing section A 707, a printer inherent processing section B 708 and an image data form creation processing section 709.

The film scan data processing section 702 applies various kinds of processing operations to the image data inputted from the film scanner section 9, such as a calibrating operation inherent to the film scanner section 9, a negative-to-positive reversal processing (in the case of the negative original), an operation for removing contamination and scars, a contrast adjusting operation, an operation for eliminating granular noise, a sharpness enhancement, etc. Then, the film scan data processing section 702 outputs the processed image data to the image adjustment processing section 701, as well as the information pertaining to the film size, the classification of negative or positive, the major subject optically or magnetically recorded on a film, the image-capturing conditions (for instance, contents of the information recorded in APS), etc.

The reflective document scan data processing section 703 applies various kinds of processing operations to the image data inputted from the reflective document input apparatus 10, such as a calibrating operation inherent to the reflective document input apparatus 10, a negative-to-positive reversal processing (in the case of the negative original), an operation for removing contamination and scars, a contrast adjusting operation, an operation for eliminating noise, a sharpness enhancement, etc. to the image data inputted from, and then outputs the processed image data to the image adjustment processing section 701.

The image data form the decoding processing section 704 applies a processing of decompression of the compressed symbol, a conversion of color data representation method, etc., to the image data inputted from an image transfer section 30a and/or the communications section (input) 32, as needed, according to the format of the inputted image data, and converts the image data into the format suited for computation in the image processing section 70. Then, the image data form the decoding processing section 704 outputs the processed data, to the image adjustment processing section 701. When the size of the output image is designated by any one of the operation section 11, the communications section (input) 32 and the image transfer section 30, the image data form the decoding processing section 704 detects the designated information, and outputs it to the image adjustment processing section 701. Information pertaining to the size of the output image designated by the image transfer section 30 is embedded in the header information and the tag information acquired by the image transfer section 30.

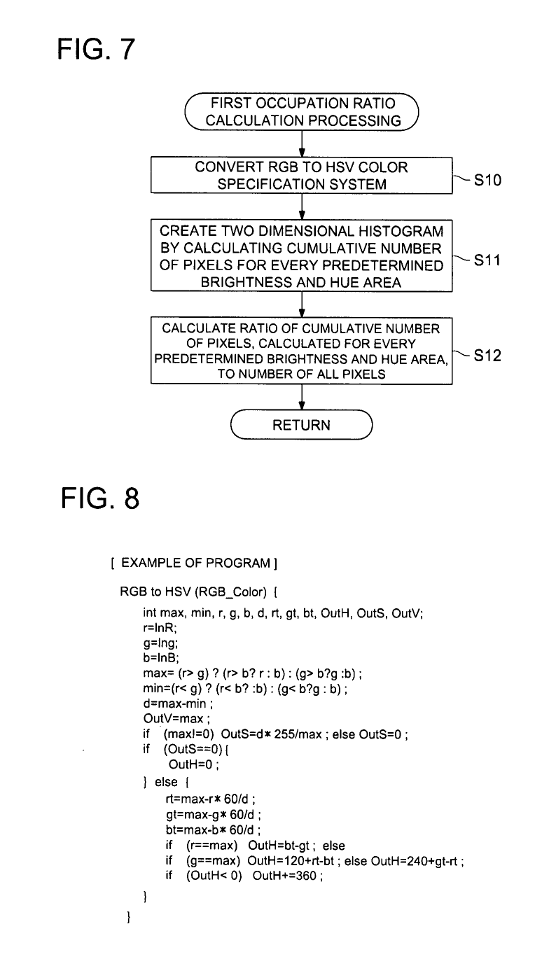

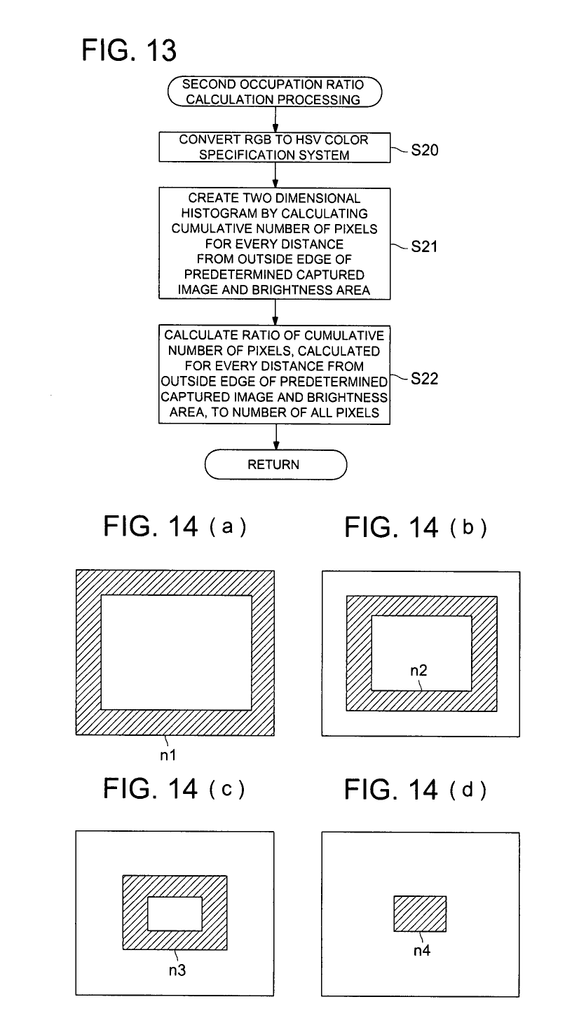

Based on the instruction command sent from the operation section 11 or the control section 7, the image adjustment processing section 701 applies image processing (detailed later, refer to FIG. 6, FIG. 7, FIG. 13 and FIG. 17) to the image data received from the film scanner section 9, the reflective document input apparatus 10, the image transfer section 30, the communications section (input) 32 and the template processing section 705, so as to create digital image data, which is to be employed for an image forming operation and optimized for viewing a reproduced image on an output medium, and then, outputs the created digital image data to the CRT inherent processing section 706, the printer inherent processing section A 707, the printer inherent processing section B 708, the image data form creation processing section 709 and the data accumulation section 71.

In the optimization processing, when it is premised that the image is displayed on the CRT displaying monitor based on, for instance, the sRGB standard, the image data is processed so as to acquire an optimum color reproduction within the color space specified by the sRGB standard. While, when it is premised that the image is outputted onto a silver-halide photosensitive paper, the image data is processed so as to acquire an optimum color reproduction within the color space specified by the silver-halide photosensitive paper. Further, other than the color space compression processing mentioned in the above, a gradation compression processing from 16 bits to 8 bits, a processing for reducing a number of output pixels, a processing for corresponding to output characteristics (LUT) of an output device to be employed, etc. are included in the optimization processing. Still further, it is needless to say that an operation for suppressing noise, a sharpness enhancement, a gray-balance adjustment, a chroma saturation adjustment, a dodging operation, etc. are also applied to the image data.

As shown in FIG. 3, the image adjustment processing section 701 is constituted by the scene determining section 710 for determining the gradation processing condition (gradation adjusting method, gradation adjusting amount) by judging the photographic condition of the captured image data and the gradation converting section 711 for conducting the gradation conversion processing according to the gradation processing condition determined in the above.

In the present embodiment, the photographic condition is classified into the light source condition and the exposure condition.

The light source condition is originated from the positional relationship between the positions of the light source, the main subject (mainly, a human posture) and the photographer. In a wide sense, the light source condition includes kinds of light sources, such as sunlight, a strobe light, a tungsten illumination and a fluorescence light. A backlight scene is caused by positioning the sun into the background of the main subject. Further, a strobe lighting scene (near field photographing) is caused by strongly irradiating a strobe light onto the main subject. As for the both of scenes abovementioned, the photographic luminance (namely, a ratio of bright and dark) of them are the same, but the relationships between the foreground and the background are merely reversed to each other.

On the other hand, the exposure condition is originated from the camera settings, such as the shutter speed, the aperture value, etc., and a state of insufficient exposure, a state of appropriate exposure and a state of excessive exposure are called “Under”, “Normal” and “Over”, respectively. In a wide sense, these also include a “White saturation” and “Shadow saturation”. With respect to all of the light source conditions, it is possible to set the exposure condition at either “Under” or “Over”. Specifically in the DSC (Digital Still Camera) whose dynamic range is relatively narrow, even if the automatic exposure adjusting function is employed, the frequency of setting the exposure condition towards the “Under” side is relatively high, due to the setting conditions for the purpose of suppressing the “White saturation”.

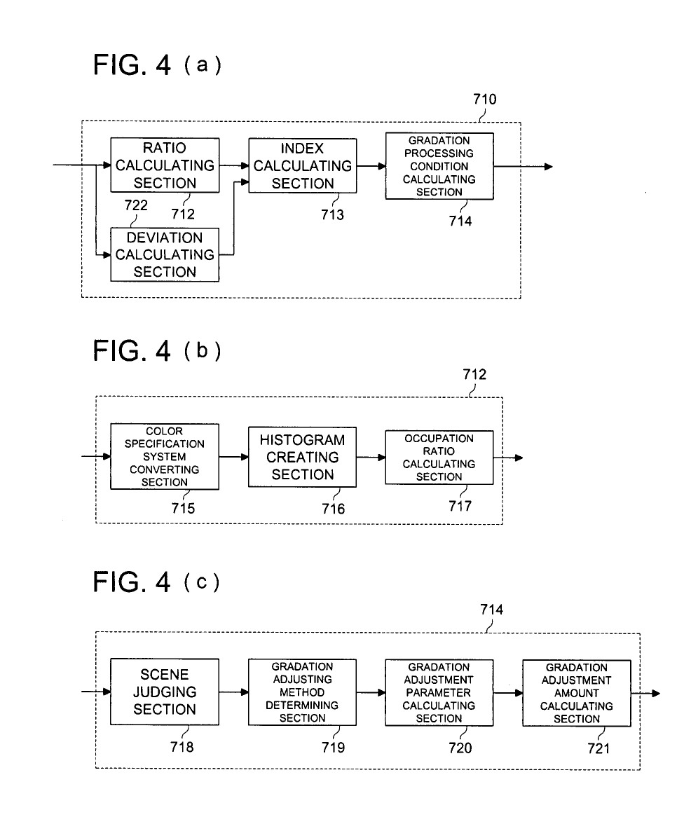

FIG. 4(a) shows an internal configuration of the scene determining section 710. As shown in FIG. 4(a), the scene determining section 710 is constituted by the a ratio calculating section 712, a deviation calculating section 722, an index calculating section 713 and a gradation processing condition calculating section 714. As shown in FIG. 4(b), the ratio calculating section 712 is constituted by a color specification system converting section 715, a histogram creating section 716 and an occupation ratio calculating section 717.

The color specification system converting section 715 converts RGB (Red, Green, Blue) values of the captured image data to the HSV color specification system. In HSV color specification system, which was devised on the basis of the color specification system proposed by Munsell, a color is represented by three elemental attributes, namely, hue, saturation and brightness (or value).

In this connection, in the scope of the claims and the present embodiment, the term of “brightness” is defined as a luminance degree to be employed as a general term unless otherwise specified. Although value “V” (in a range of 0-255) of the HSV color specification system will be employed as the brightness in the following descriptions, a unit system representing the brightness of any other color specification system is also applicable in the present embodiment. In that case, it is needless to say that various kinds of coefficients, etc., to be employed in the present embodiment, should be recalculated. Further, in the present embodiment, it is assumed that the captured image data represents an image in which a human posture is a main subject.

The histogram creating section 716 divides the captured image data into areas, each of which is a combination of hue and brightness, and creates a two dimensional histogram by calculating a cumulative number of pixels for every area. Further, the histogram creating section 716 divides the captured image data into predetermined areas, each of which is a combination of a distance from an outside edge of the image represented by the captured image data and brightness, and creates a two dimensional histogram by calculating a cumulative number of pixels for every area. In this connection, it is also applicable that the captured image data are divided into areas, each of which is a combination of a distance from an outside edge of the image represented by the captured image data, brightness and hue, and creates a three dimensional histogram by calculating a cumulative number of pixels for every area. In the following, it is assumed that the method for creating the two dimensional histogram is employed.

The occupation ratio calculating section 717 calculates a first occupation ratio (refer to Table 1) indicating a ratio of each of the divided areas to a total number of pixels (a whole body of the digital image data) of the cumulative number of pixels calculated by the histogram creating section 716 for every area, which is divided by a combination of hue and brightness. Further, the occupation ratio calculating section 717 calculates a second occupation ratio (refer to Table 4) indicating a ratio of each of the divided areas to a total number of pixels (a whole body of the digital image data) of the cumulative number of pixels calculated by the histogram creating section 716 for every area, which is divided by a combination of a distance from an outside edge of the image represented by the captured image data and brightness.

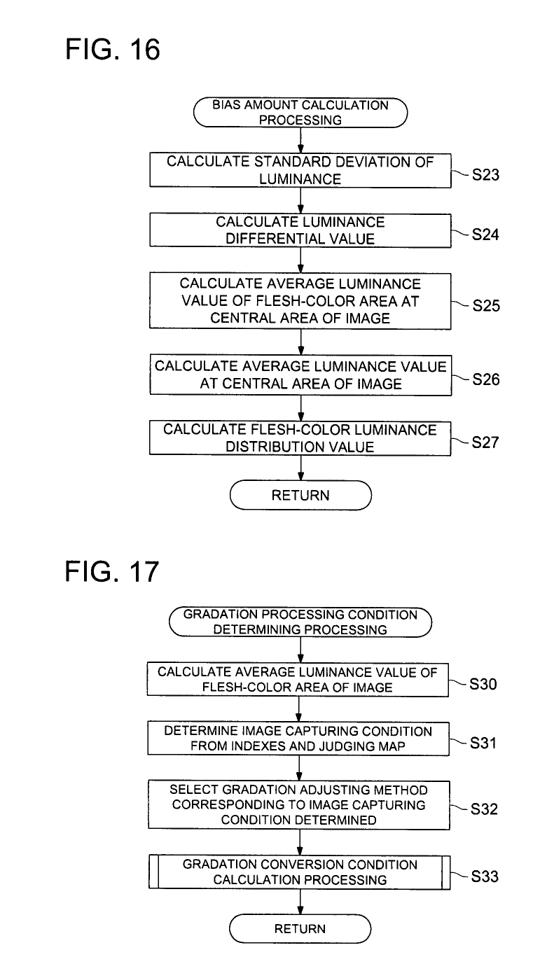

The deviation calculating section 722 calculates a bias amount indicating a deviation of a gradation distribution of the captured image data. Hereinafter, the term of the “bias amount” is defined as a standard deviation of luminance values of the captured image data, a differential luminance value, an average luminance value of skin color at a central area of the screen, an average luminance value at a central area of the screen and a skin color distribution value. Such the calculation processing of the bias amount will be detailed later by referring to FIG. 16.

The index calculating section 713 calculates an index 1 for specifying the image capturing condition by multiplying the first occupation ratio (refer to Table 2), calculated for every area by the occupation ratio calculating section 717, by a first coefficient established in advance corresponding to the image capturing condition (for instance, a judging analysis), and summing them. The index 1 indicates characteristics at the time of the strobe image capturing operation, such as a degree of in-house photographing, a degree of near sight photographing, a degree of face highlighting, etc., and serves as an index for separating an image to be judged as the strobe form other image capturing conditions.

When calculating the index 1, the index calculating section 713 employs coefficients, the signs of which are different from each other between a predetermined flesh-color area having high brightness and a hue area other than the flesh-color area having the high brightness. In this connection, the predetermined flesh-color area includes an area having a brightness value in a range of 170-224 of the HSV color specification system. Further, the hue area, other than the predetermined flesh-color area having the high brightness, includes at least one of areas, having the high brightness, of a blue hue area (having a hue value in a range of 161-250) and a green hue area (having a hue value in a range of 40-160).

The index calculating section 713 calculates an index 2 for specifying the image capturing condition by multiplying the first occupation ratio (refer to Table 3), calculated for every area by the occupation ratio calculating section 717, by a second coefficient established in advance corresponding to the image capturing condition (for instance, a judging analysis), and summing them. The index 2 indicates characteristics at the time of the backlight image capturing operation, such as a degree of outside photographing, a degree of sky color highlighting, a degree of face shadowing, etc., and serves as an index for separating an image to be judged as the backlight form other image capturing conditions.

When calculating the index 2, the index calculating section 713 employs coefficients, the signs of which are different from each other between a flesh-color area having intermediate brightness and a hue area other than the flesh-color area having the intermediate brightness. In this connection, the flesh-color area, having the intermediate brightness, includes an area having a brightness value in a range of 85-169. Further, the hue area, other than the predetermined flesh-color area having the intermediate brightness, includes a shadow area (having a brightness value in a range of 26-84).

Further, the index calculating section 713 calculates an index 3 for specifying the image capturing condition by multiplying the second occupation ratio (refer to Table 5), calculated for every area by the occupation ratio calculating section 717, by a third coefficient established in advance corresponding to the image capturing condition (for instance, a judging analysis), and summing them. The index 3 indicates a difference of bright-to-dark relationship between the central area and an outside area of the image represented by the captured image data, and serves as an index for quantitatively indicating only an image to be judged as the backlight or the strobe. When calculating the index 3, the index calculating section 713 employs coefficients, which vary corresponding to the distance from the outside edge of the image represented by the captured image data.

Still further, the index calculating section 713 calculates an index 4 by multiplying the index 1, the index 3 and the average luminance value of the flesh-color area, located at the central area of the image represented by the captured image data, by a coefficient established in advance corresponding to the image capturing condition (for instance, a judging analysis), and summing them. Still further, the index calculating section 713 calculates an index 5 by multiplying the index 2, the index 3 and the average luminance value of the flesh-color area, located at the central area of the image, by a coefficient established in advance corresponding to the image capturing condition (for instance, a judging analysis), and summing them. Further, the index calculating section 713 calculates an index 6 by multiplying the bias amount, calculated by the deviation calculating section 722, by a fourth coefficient (refer to Table 6) established in advance corresponding to the image capturing condition (for instance, a judging analysis), and summing them. The concrete method for calculating the indexes 1-6 will be detailed later in the descriptions of the operations in the present embodiment.

FIG. 4(c) shows an internal configuration of the gradation processing condition calculating section 714. As shown in FIG. 4(c), the gradation processing condition calculating section 714 is constituted by a scene judging section 718, a gradation adjusting method determining section 719, a gradation adjustment parameter calculating section 720 and a gradation adjustment amount calculating section 721.

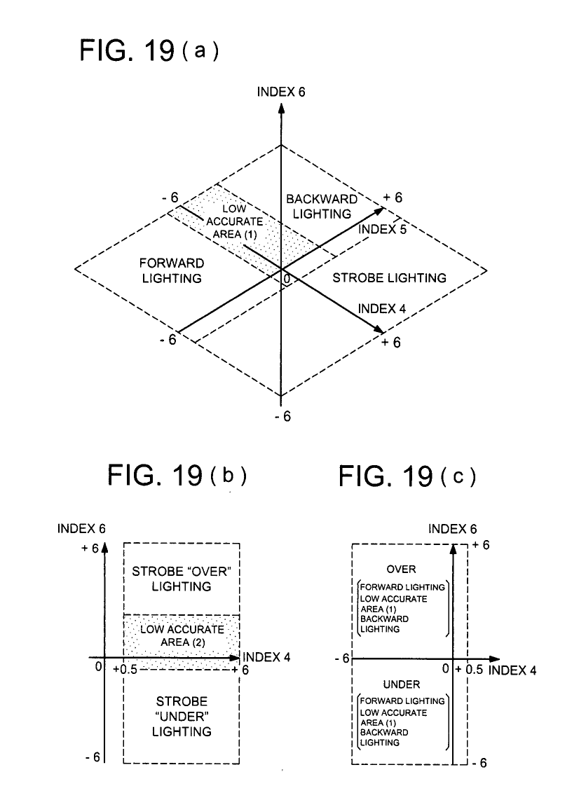

The scene judging section 718 determines the image capturing condition of the captured image data, based on the values of index 4, index 5 and index 6 calculated by the index calculating section 713, and a judging map (refer to FIG. 19) for evaluating reliability of the index, which is divided into areas in advance corresponding to accuracy of the image capturing condition.

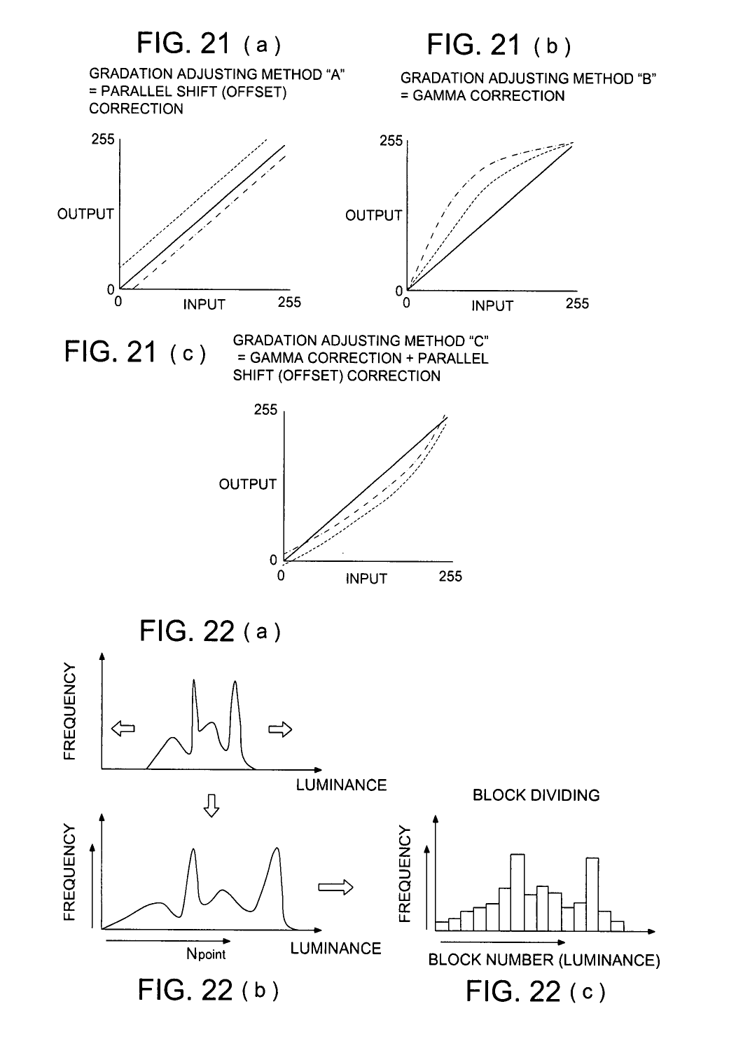

The gradation adjusting method determining section 719 determines a method for adjusting the gradation in respect to the captured image data, corresponding to the image capturing condition determined by the scene judging section 718. For instance, when the image capturing condition is determined as a “forward lighting” or a “strobe over lighting”, as shown in FIG. 21(a), a correction method for shifting (offsetting) the pixel values of the inputted captured image data in parallel (gradation adjusting method “A”) is employed. While, when the image capturing condition is determined as a “backward lighting” or a “strobe under lighting”, as shown in FIG. 21(b), a correction method for applying a gamma correction to the pixel values of the inputted captured image data (gradation adjusting method “B”) is employed. Further, when the image capturing condition is determined as an intermediate lighting (low accuracy area (1)) between the “backward lighting” and the “forward lighting”, or another intermediate lighting (low accuracy area (2)) between the “strobe over lighting” and the “strobe under lighting”, as shown in FIG. 21(c), a correction method for applying a gamma correction to the pixel values of the inputted captured image data and shifting (offsetting) the pixel values of the inputted captured image data in parallel (gradation adjusting method “C”) is employed.

The gradation adjustment parameter calculating section 720 calculates parameters necessary for the gradation adjustment (an average luminance value in the flesh-color area (flesh-color average luminance value), a luminance correction value, etc.), based on the values of index 4, index 5 and index 6 calculated by the index calculating section 713.

The gradation adjustment amount calculating section 721 calculates gradation adjustment amounts for the captured image data, based on the index values calculated by the index calculating section 713 and the gradation adjustment parameters calculated by the gradation adjustment parameter calculating section 720.

In this connection, the method for determining the image capturing condition in the scene judging section 718, the method for calculating gradation adjustment parameter in the gradation adjustment parameter calculating section 720, the method for calculating the gradation adjustment amount (gradation conversion condition) in the gradation adjustment amount calculating section 721 will be detailed later in the descriptions of the operations in the present embodiment.

In FIG. 3, the gradation converting section 711 applies the gradation conversion processing based on the gradation adjustment amount calculated by the gradation adjustment amount calculating section 721, to the captured image data.

Based on the instruction command sent from image adjustment processing section 701, the template processing section 705 reads the predetermined image data (template image data) from template storage 72 so as to conduct a template processing for synthesizing the image data, being as an image-processing object, with the template image data, and then, outputs the synthesized image data to image adjustment processing section 701.

The CRT inherent processing section 706 applies processing operations for changing the number of pixels and color matching, etc. to the image data inputted from the image adjustment processing section 701, as needed, and outputs the output image data of displaying use, which are synthesized with information such as control information, etc. to be displayed on the screen, to the CRT 8.

The printer inherent processing section A 707 conducts the calibration processing inherent to the printer and processing operations of color matching and changing the number of pixels, etc. as needed, and outputs the processed image data to the exposure processing section 4.

When the external printer 51, such as a large-sized inkjet printer, etc., is connectable to the image recording apparatus 1 embodied in the present invention, the printer inherent processing section B 708 is provided for every printer to be connected. The printer inherent processing section B 708 conducts the calibration processing inherent to the printer and processing operations of color matching and changing the number of pixels, etc. as needed, and outputs the processed image data to the external printer 51.

The image data form creation processing section 709 applies a data-format conversion processing to the image data inputted from the image adjustment processing section 701, as needed, so as to convert the data-format of the image data to one of various kinds of general-purpose image formants represented by JPEG, TIFF and Exif, and outputs the processed image data to the image transport section 31 and the communications section (output) 33.

In this connection, the divided blocks of the film scan data processing section 702, the reflective document scan data processing section 703, the image data form decoding processing section 704, the image adjustment processing section 701, the CRT inherent processing section 706, the printer inherent processing section A 707, the printer inherent processing section B 708 and the image data form creation processing section 709, as shown in FIG. 3, are provided to assist understanding of the functions of the image processing section 70. Therefore, each of divided blocks is not necessary functioned as a physically independent device. For instance, it is also applicable that each of divided blocks is functioned as one categorized processing of software executed by a single computer.

Next, the operations of the present invention will be detailed in the following.

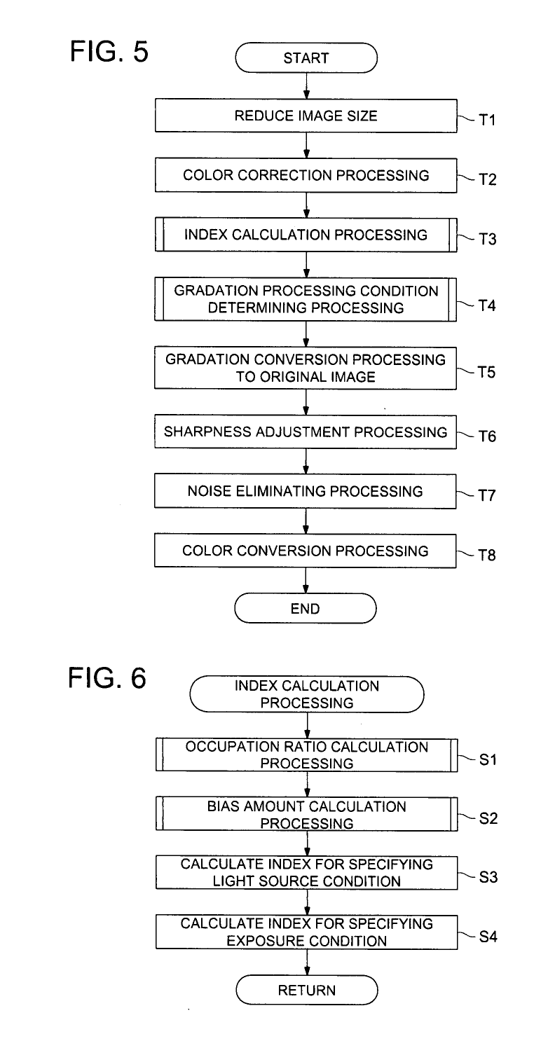

Initially, referring to the flowchart shown in FIG. 5, the flow of the processing to be conducted in the image adjustment processing section 701 will be detailed in the following.

At first, the size of the captured image data is reduced (Step T1). The well-known method (for instance, a bilinear method, a bi-cubic method, a nearest neighbor method, etc.) can be employed as the method for reducing the size of the captured image data. Although the reduction ratio is not specifically limited, it is preferable that the reduction ratio is set at a value in a range of ½- 1/10 of its original size, from the viewpoints of the processing velocity and the judging accuracy of the image capturing condition.

Successively, the correction processing of the white balance of the DSC is applied to the reduced captured image data (Step T2), and then, the index calculation processing for calculating the indexes (indexes 1-6) for specifying the image capturing condition (Step T3). With respect to the index calculation processing to be performed in Step T3, detailed explanations will be provided later on, referring to FIG. 6.

Still successively, by determining the image capturing condition of the captured image data, based on the indexes calculated in the Step T3 and the judging map, the gradation processing condition determining processing for determining the gradation processing condition (gradation adjustment method, gradation adjustment amount) for the captured image data is conducted (Step T4). With respect to the gradation processing condition determining processing to be performed in Step T4, detailed explanations will be provided later on, referring to FIG. 17.

Still successively, the gradation conversion processing is applied to the original captured image data, according to the gradation processing condition determined in Step T4 (Step T5). Then, the processing for adjusting the sharpness is applied to the captured image data to which the gradation conversion processing is already applied (Step T6). In Step T6, it is preferable that an amount of processing is adjusted corresponding to the image capturing condition concerned and the size of the print to be outputted.

Still successively, the processing for hardening tone by the gradation adjustment and the processing for eliminating noises caused by the sharpness enhancing operation are applied to the original captured image data (Step T5). Yet successively, the color conversion processing for converting the color space according to a kind of medium to which the processed captured image data are to be outputted (Step T8), and then, the processed captured image data are outputted into the medium designated.

Next, referring to the flowchart shown in FIG. 6, the index calculation processing (Step The index calculation processing 3 shown in FIG. 5) to be conducted by the scene determining section 710. In the index calculation processing described in the following, the term of the “captured image data” represents the reduced image data reduced in the Step T1 shown in FIG. 5.

At first, the captured image data are divided into predetermined areas, and then, the occupation ratio calculation processing for calculating the occupation ratio (first occupation ratio, second occupation ratio) indicating a ratio of each of the areas to all of the captured image data is conducted (Step S1). The occupation ratio calculation processing will be detailed later on, referring to FIG. 7 and FIG. 13.

Successively, the deviation calculating section 722 conducts the bias amount calculation processing for calculating the bias amount indicating the deviation of the gradation distribution of the captured image data (Step S2). The bias amount calculation processing to be conducted in Step S2 will be detailed later on, referring to FIG. 16.

Still successively, an index for specifying the light source condition is calculated, based on the occupation ratio calculated by the ratio calculating section 712 and the coefficient established in advance corresponding to the light source condition (Step S3). Further, an index for specifying the exposure condition is calculated, based on the occupation ratio calculated by the ratio calculating section 712 and the coefficient established in advance corresponding to the exposure condition (Step S4). Then, the index calculation processing is finalized. The method for calculating the indexes in Step S3 and Step S4 will be detailed later on.

Next, referring to the flowchart shown in FIG. 7, the first occupation ratio calculation processing to be performed in the ratio calculating section 712 will be detailed in the following.

At first, the RGB values of the captured image data are converted to the values of the HSV color specification system (Step S10). FIG. 8 shows an exemplary program (HSV conversion program) for converting the RGB values to the values of the HSV color specification system, so as to acquire the hue value, the saturation value and the brightness value, which is described in the program codes (C Language). In the HSV conversion program shown in FIG. 8, the values of the digital image data, serving as inputted image data, are defined as InR, InG, InB, and the calculated hue value is defined as OutH. Further, the scale, the saturation value, the brightness value and the unit are defined as in a range of 0-360, OutS, OutV and in a range of 0-225, respectively.

Successively, the captured image data are divided into areas, each of which is composed of a combination of the predetermined brightness and hue, and the two dimensional histogram is created by calculating the cumulative number of pixels for every divided area (Step S11). The area dividing operation of the captured image data will be detailed in the following.

The brightness (V) is divided into seven areas, brightness values of which are in a range of 0-25 (v1), in a range of 26-50 (v2), in a range of 51-84 (v3), in a range of 85-169 (v4), in a range of 170-199 (v5), in a range of 200-224 (v6) and in a range of 225-255 (v7), respectively. Further, the hue (H) is divided into four areas, which include a flesh-color hue area (H1 and H2) whose hue values is in a range of 0-39 and in a range of 330-359, a green hue area (H3) whose hue value is in a range of 40-160, a blue hue area (H4) whose hue value is in a range of 161-250 and a red hue area (H5). From the acquired knowledge that the red hue area (H5) contributes a little to the judging operation of the image capturing condition, the red hue area (H5) is not employed in the following calculations. The flesh-color hue area is further divided into the flesh-color area (H1) and the area (H2) other than the flesh-color area. In the following, among the flesh-color hue area (H=0-39, 330-359), the hue′ (H) that fulfills Equation (1) is defined as the flesh-color area (H1), while area that does not fulfill Equation (1) is defined as the area (H2).
10<saturation (S)<175,

hue′ (H)=hue (H)+60 (when 0≦hue (H)<300)

hue′ (H)=hue (H)−300 (when 300≦hue (H)<360)

luminance (Y)=InR×0.30+InG×0.59+InB×0.11 (A)

hue′ (H)/luminance (Y)<3.0×(saturation (S)/255)+0.7 (1)

Accordingly, the number of the divided areas of the captured image data is 4×7=28 areas. Further, it is also possible to employ brightness (V) in Equation (1).

When the two dimensional histogram is created, the first occupation ratio indicating a ratio of the cumulative number of pixels, calculated for every divided area, to the number of all pixels (whole body of the captured image data) is calculated (Step S12), and then, this occupation ratio calculation processing is finalized. Establishing that the first occupation ratio calculated in the divided area, composed of a combination of the brightness area vi and the hue area Hj, is Rij, the first occupation ratio in each of the divided areas is indicated as shown in Table 1.

TABLE 1
[FIRST OCCUPATION RATIO]

| | H1 | H2 | H3 | H4 |
|---|---|---|---|---|
| v1 | R11 | R12 | R13 | R14 |
| v2 | R21 | R22 | R23 | R24 |
| v3 | R31 | R32 | R33 | R34 |
| v4 | R41 | R42 | R43 | R44 |
| v5 | R51 | R52 | R53 | R54 |
| v6 | R61 | R62 | R63 | R64 |
| v7 | R71 | R72 | R73 | R74 |

Next, the method of calculating the index 1 and the index 2 will be detailed in the following.

Table 2 shows the first coefficient necessary for calculating the index 1, which indicates an accuracy of the strobe image capturing operation, namely, which quantitatively indicates a brightness status of the human face area at the time of the strobe image capturing operation, for every divided area. The coefficient indicated in Table 2 is a weighted coefficient by which the first occupation ratio Rij shown in Table 1 is multiplied, and is established in advance corresponding to the light source condition.

TABLE 2
[FIRST COEFFICIENT]

| | H1 | H2 | H3 | H4 |
|---|---|---|---|---|
| v1 | −44.0 | 0.0 | 0.0 | 0.0 |
| v2 | −16.0 | 8.6 | −6.3 | −1.8 |
| v3 | −8.9 | 0.9 | −8.6 | −6.3 |
| v4 | −3.6 | −10.8 | −10.9 | −7.3 |
| v5 | 13.1 | 20.9 | −25.8 | −9.3 |
| v6 | 8.3 | −11.3 | 0.0 | −12.0 |
| v7 | −11.3 | −11.1 | −10.0 | −14.6 |

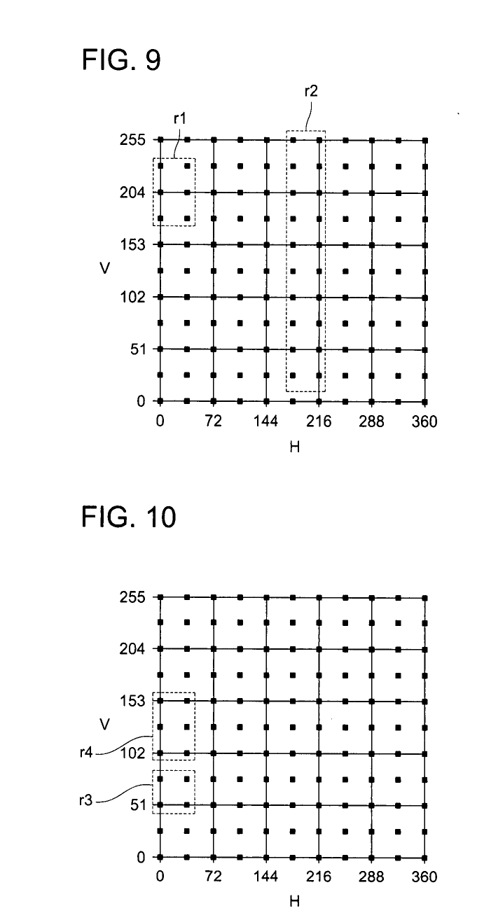

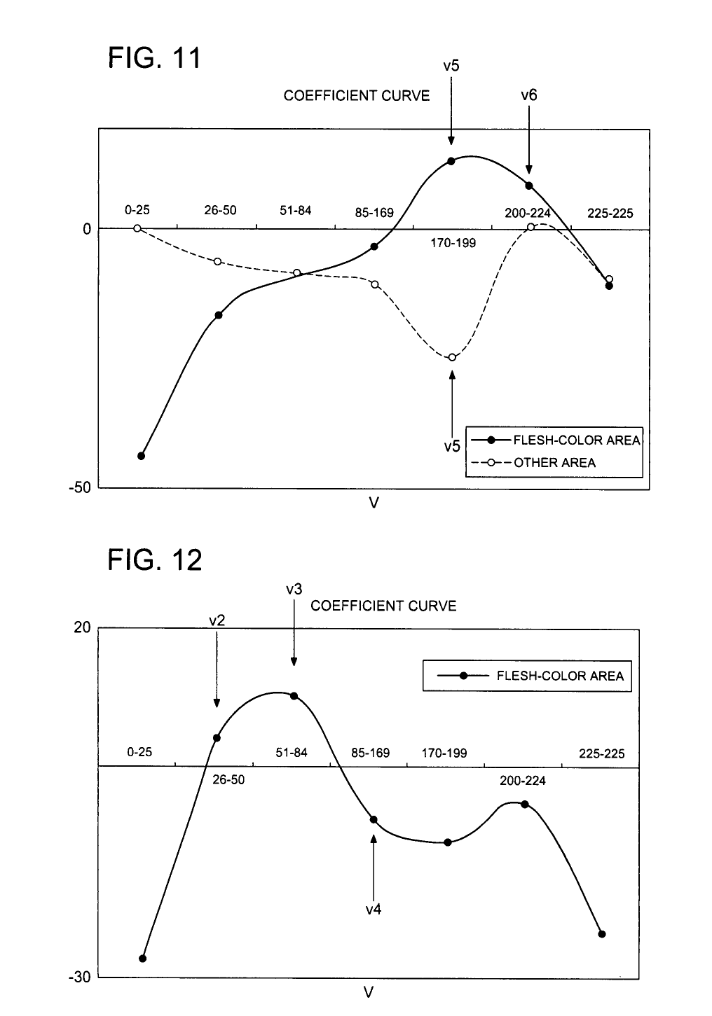

FIG. 9 shows a brightness (v)-hue (H) plane. According to Table 2, a positive (+) coefficient is employed for the first occupation ratio, which is calculated from an area (r1) distributing over the high brightness flesh-color area in FIG. 9, while a negative (−) coefficient is employed for the other first occupation ratio, which is calculated from a blue hue area (r2) being a hue other than the above. FIG. 11 shows a graph indicating the first coefficient in the flesh-color area (H1) and the other first coefficient in the other area (green hue area (H3)) as curved lines (coefficient curves), each of which continuously changes over the whole brightness. According to Table 2 and FIG. 11, in the high brightness area (V=170-224), the sign of first coefficient in the flesh-color area (H1) is positive (+), while, in the other area (for instance, the green hue area (H3)), the sign of first coefficient is negative (−). Accordingly, it is recognized that the sings of both of them are different from each other.

Establishing that the first coefficient in the brightness area vi and the hue area Hj is Cij, a sum in the Hk area for calculating the index 1 is defined as Equation (2) shown as follow.

$$Sum of Hk areas = {\sum }_{i = 1}^{7} Rik \times Cik \qquad ( 2 )$$

Accordingly, sums of areas H1-H4 are indicated by Equations (2-1)-(2-4) shown as follows.

Sum of area H1=R11×(−44.0)+R21×(−16.0)+ . . . +R71×(−11.3) (2-1)

Sum of area H2=R12×0.0+R22×8.6+ . . . +R72×(−11.1) (2-2)

Sum of area H3=R13×0.0+R23×(−6.3)+ . . . +R73×(−10.0) (2-3)

Sum of area H4=R14×0.0+R24×(−1.8)+ . . . +R74×(−14.6) (2-4)

By employing the sums of areas H1-H4 indicated by Equations (2-1)-(2-4), the index 1 is defined as Equation (3) shown as follow.

Index 1=“Sum of area H1”+“Sum of area H2”+“Sum of area H3”+“Sum of area H4”+4.424 (3)

Table 3 indicates the second coefficient necessary for calculating the index 2, which indicates an accuracy of the backlight image capturing operation, namely, which quantitatively indicates a brightness status of the human face area at the time of the backlight image capturing operation, for every divided area. The coefficient indicated in Table 3 is a weighted coefficient by which the first occupation ratio Rij shown in Table 1 is multiplied, and is established in advance corresponding to the light source condition.

TABLE 3
[SECOND COEFFICIENT]

| | H1 | H2 | H3 | H4 |
|---|---|---|---|---|
| v1 | −27.0 | 0.0 | 0.0 | 0.0 |
| v2 | 4.5 | 4.7 | 0.0 | −5.1 |
| v3 | 10.2 | 9.5 | 0.0 | −3.4 |
| v4 | −7.3 | −12.7 | −6.5 | −1.1 |
| v5 | −10.9 | −15.1 | −12.9 | 2.3 |
| v6 | −5.5 | 10.5 | 0.0 | 4.9 |
| v7 | −24.0 | −8.5 | 0.0 | 7.2 |

FIG. 10 shows another brightness (v)-hue (H) plane. According to Table 3, a negative (−) coefficient is employed for the occupation ratio, which is calculated from an area (r4) distributing over the intermediate brightness of the flesh-color area in FIG. 10, while a positive (−) coefficient is employed for the other occupation ratio, which is calculated from a low brightness (shadow) area (r3) within the flesh-color area. FIG. 12 shows a graph indicating the second coefficient in the flesh-color area (H1) as a curved line (coefficient curve), which continuously changes over the whole brightness. According to Table 3 and FIG. 12, in the intermediate brightness area in which the brightness value is in a range of 85-169 (v4), the sign of the second coefficient is negative (−), while, in the low brightness (shadow) area in which the brightness value is in a range of 26-84 (v2, v3), the sign of second coefficient is positive (+). Accordingly, it is recognized that the sings of both areas are different from each other.

Establishing that the second coefficient in the brightness area vi and the hue area Hj is Dij, a sum in the Hk area for calculating the index 2 is defined as Equation (4) shown as follow.

$$Sum of Hk areas = {\sum }_{i = 1}^{7} Rik \times Dik \qquad ( 4 )$$

Accordingly, sums of areas H1-H4 are indicated by Equations (4-1)-(4-4) shown as follows.

Sum of area H1=R11×(−27.0)+R21×4.5+ . . . +R71×(−24.0) (4-1)

Sum of area H2=R12×0.0+R22×4.7+ . . . +R72×(−8.5) (4-2)

Sum of area H3=R13×0.0+R23×0.0+ . . . +R73×0.0 (4-3)

Sum of area H4=R14×0.0+R24×(−5.1)+ . . . +R74×7.2 (4-4)

By employing the sums of areas H1-H4 indicated by Equations (2-1)-(2-4), the index 2 is defined as Equation (5) shown as follow.

Index 1=“Sum of area H1”+“Sum of area H2”+“Sum of area H3”+“Sum of area H4”+1.554 (5)

Since the index 1 and the index 2 are calculated on the basis of the distribution amount of brightness and hue of the captured image data, both are effective for determining the image capturing condition when the captured image data represent a color image.

Next, referring to the flowchart shown in FIG. 13, the second occupation ratio calculation processing, to, be performed in the ratio calculating section 712 for calculating the index 3, will be detailed in the following.

At first, the RGB values of the captured image data are converted to the values of the HSV color specification system (Step S20). Successively, the captured image data are divided into areas, each of which is composed of distances from an outside edge of an image represented by the captured image data and brightness, and the two dimensional histogram is created by calculating the cumulative number of pixels for every divided area (Step S21). The area dividing operation of the captured image data will be detailed in the following.

FIG. 14(a), FIG. 14(b), FIG. 14(c), and FIG. 14(d) show four areas n1, n2, n3 and n4, which are divided corresponding to the distances from an outside edge of an image represented by the captured image data, respectively. The area n1 shown in FIG. 14(a) is an outer frame area, the area n2 shown in FIG. 14(b) is an area inside the outer frame area, the area n3 shown in FIG. 14(c) is an area further inside the area n2 and the area n4 shown in FIG. 14(d) is an area located at the central position. Further, the brightness is divided into seven areas v1-v7, as aforementioned. Accordingly, the number of the divided areas is 4×7=28 areas, when dividing the captured image data into the areas, each of which is composed of distances from an outside edge of an image represented by the captured image data and brightness.

When the two dimensional histogram is created, the second occupation ratio indicating a ratio of the cumulative number of pixels, calculated for every divided area, to the number of all pixels (whole body of the captured image data) is calculated (Step S22), and then, this occupation ratio calculation processing is finalized. Establishing that the second occupation ratio calculated in the divided area, composed of a combination of the brightness area vi and the hue area Hj, is Qij, the second occupation ratio in each of the divided areas is indicated as shown in Table 4.

TABLE 4
[SECOND OCCUPATION RATIO]

| | n1 | n2 | n3 | n4 |
|---|---|---|---|---|
| v1 | Q11 | Q12 | Q13 | Q14 |
| v2 | Q21 | Q22 | Q23 | Q24 |
| v3 | Q31 | Q32 | Q33 | Q34 |
| v4 | Q41 | Q42 | Q43 | Q44 |
| v5 | Q51 | Q52 | Q53 | Q54 |
| v6 | Q61 | Q62 | Q63 | Q64 |
| v7 | Q71 | Q72 | Q73 | Q74 |

Next, the method of calculating the index 3 will be detailed in the following.

Table 5 shows the third coefficient necessary for calculating the index 3 for every divided area. The coefficient indicated in Table 5 is a weighted coefficient by which the first occupation ratio Qij shown in Table 4 is multiplied, and is established in advance corresponding to the light source condition.

TABLE 5
[THIRD COEFFICIENT]

| | n1 | n2 | n3 | n4 |
|---|---|---|---|---|
| v1 | 40.1 | −14.8 | 24.6 | 1.5 |
| v2 | 37.0 | −10.5 | 12.1 | −32.9 |
| v3 | 34.0 | −8.0 | 0.0 | 0.0 |
| v4 | 27.0 | 2.4 | 0.0 | 0.0 |
| v5 | 10.0 | 12.7 | 0.0 | −10.1 |
| v6 | 20.0 | 0.0 | 5.8 | 104.4 |
| v7 | 22.0 | 0.0 | 10.1 | −52.2 |

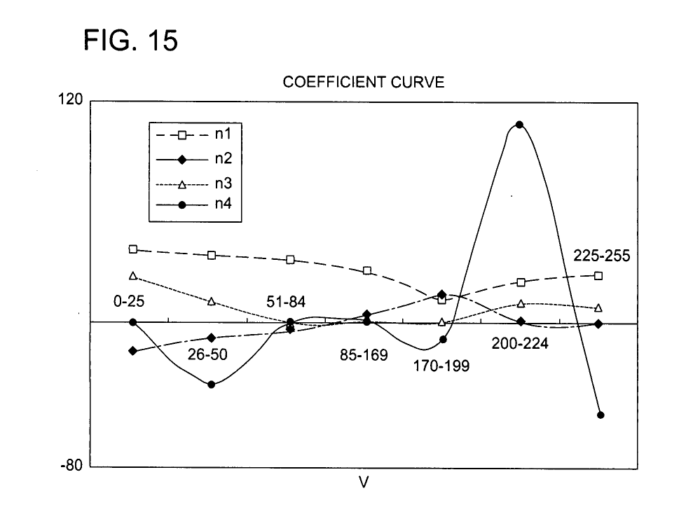

FIG. 15 shows a graph indicating the third coefficients in the image areas n1-n4 as curved lines (coefficient curves), each of which continuously changes over the whole brightness.

Establishing that the third coefficient in the brightness area vi and the image area nj is Eij, a sum in the nk area (image area nk) for calculating the index 3 is defined as Equation (6) shown as follow.

$$Sum of nk areas = {\sum }_{i = 1}^{7} Qik \times Eik \qquad ( 6 )$$

Accordingly, sums of areas n1-n4 are indicated by Equations (6-1)-(6-4) shown as follows.

Sum of area n1=Q11×40.1+Q21×37.0+ . . . +Q71×22.0 (6-1)

Sum of area n2=Q12×(−14.8)+Q22×(−10.5)+ . . . +Q72×0.0 (6-2)

Sum of area n3=Q13×24.6+Q23×12.1+ . . . +Q73×10.1 (6-3)

Sum of area n4=Q14×1.5+Q24×(−32.9)+ . . . +Q74×(−52.2) (6-4)

By employing the sums of areas n1-n4 indicated by Equations (6-1)-(6-4), the index 3 is defined as Equation (7) shown as follow.

Index 3=“Sum of area n1”+“Sum of area n2”+“Sum of area n3”+“Sum of area n4”−12.6201 (7)

Since the index 3 is calculated on the basis of the compositional characteristics caused by the distributed positions of the brightness of the image represented by the captured image data (distances from an outside edge of an image represented by the captured image data), the index 3 is effective for determining the image capturing condition of not only a color image, but also a monochrome image.

Next, referring to the flowchart shown in FIG. 16, the bias amount calculation processing (Step S2 shown in FIG. 6) to be performed in the deviation calculating section 722 will be detailed in the following.

At first, by employing Equation (A), a luminance Y (brightness) of each pixel is calculated from values of RGB (Red, Green, Blue) of the captured image data, so as to calculate the standard deviation (x1) of luminance (Step S23). The standard deviation (x1) of luminance is defined as Equation (8) shown as follow.

$$Luminance standard deviation ( x 1 ) = \sqrt{{\sum }_{ }^{ } \frac{{( \begin{matrix}Pixel luminance value - \\ average luminance value\end{matrix} )}^{2}}{number of all pixels}} \qquad ( 8 )$$

In Equation (8), the pixel luminance value is a luminance of each of pixels represented by the captured image data, and the average luminance value is an average value of luminance values represented by the captured image data. Further, an overall pixel number is a number of all pixels included in the whole body of the captured image data.

Successively, a luminance differential value (x2) is calculated by employing Equation (9) shown as follow (Step S24).

“luminance differential value” (x2)=(“maximum luminance value”−“average luminance value”)/255 (9)

In Equation (9), the maximum luminance value is a maximum value of the luminance represented by the captured image data.

Still successively, an average luminance value (x3) of the flesh-color area at the central area of the image represented by the captured image data is calculated (Step S25), and further, another average luminance value (x4) at the central area of the image concerned is calculated (Step S26). In this connection, the central area is corresponds to, for instance, an area constituted by the area n3 and the area n4, shown in FIG. 14.

Still successively, a flesh-color luminance distribution value (x5) is calculated (Step S27), and then, the bias amount calculation processing is finalized. The flesh-color luminance distribution value (x5) is expressed by the Equation (10) shown as follow.

x5=(Yskin_max−Yskin_min)/2−Y sin_ave (10)
where Yskin_max: maximum luminance value of flesh-color area of the image represented by the captured image data,
Yskin_min: minimum luminance value of flesh-color area concerned,
Y sin_ave: average luminance value of flesh-color area concerned,

The average luminance value of the flesh-color area at the central area of the image represented by the captured image data is established as x6. In this connection, the central area is corresponds to, for instance, an area constituted by the area n2, the area n3 and the area n4, shown in FIG. 14. Then, by employing the index 1, the index 3 and x6, the index 4 is defined as Equation (11) shown as follow, while, by employing the index 2, the index 3 and x6, the index 5 is defined as Equation (12) shown as follow.

index 4=0.46×index 1+0.61×index 3+0.01×x6−0.79 (11)

index 5=0.58×index 2+0.18×index 3+(−0.03)×x6+3.34 (12)

Herein, each of the weighted coefficients, by which each of the indexes is multiplied in Equation (11) Equation (12), is established in advance corresponding to the image capturing condition.

The index 6 is acquired by multiplying the bias amounts (x1)-(x5) by the fourth coefficients established in advance corresponding to the exposure condition. The fourth coefficients, serving as weighted coefficients, by which each of the bias amounts is multiplied, are shown in Table 6.

TABLE 6
[FOURTH COEFFICIENT]

| | |
|---|---|
| x1 | 0.02 |
| x2 | 1.13 |
| x3 | 0.06 |
| x4 | −0.01 |
| x5 | 0.03 |

The index 6 is expressed by Equation (13) shown as follow.

index 6=x1×0.02+x2×1.13+x3×0.06+x4×(−0.01)+x5×0.03−6.49 (13)

Since the index 6 includes not only the compositional characteristics of the image represented by the captured image data, but also the luminance histogram distribution information, the index 6 is effective for determining whether the captured scene is “Over” or “Under” (refer to FIG. 19).

Next, referring to the flowchart shown in FIG. 17, the gradation processing condition determining processing (Step T4 shown in FIG. 5) to be performed in the gradation processing condition calculating section 714 will be detailed in the following.

At first, the average luminance value of the flesh-color area of the image represented by the captured image data (flesh-color average luminance value) is calculated (Step S30). Successively, the image capturing condition (light source condition, exposure condition) of the captured image data is determined on the basis of the indexes (index 4-6) calculated by the index calculating section 713 and the judging map divided in areas corresponding to the image capturing condition (light source condition, exposure condition) (Step S31). The determining method of the image capturing condition will be detailed in the following.

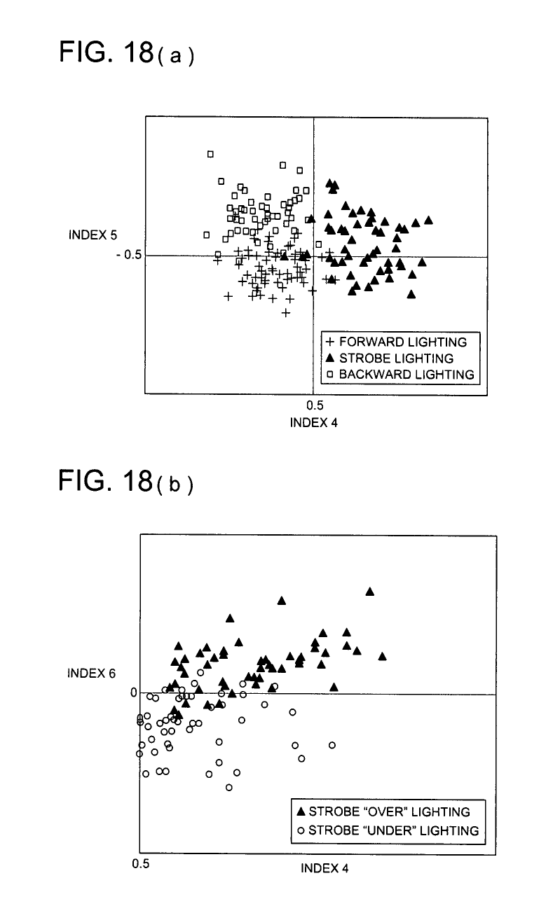

FIG. 18(a) shows a graph on which the values of the indexes 4 and the indexes 5 are plotted. In FIG. 18(a), the indexes 4 and the indexes 5 are calculated with respect to 180 digital image data sets representing the total 180 scenes, which are captured for every 60 scenes under each of the three conditions of the forward lighting, the backward lighting and the strobe lighting (strobe “Over”, strobe “Under”). FIG. 18(b) shows a graph on which the values of the indexes 4 and the indexes 6 are plotted. In FIG. 18(b), the scenes are captured for every 60 scenes under each of image capturing conditions of strobe “Over” and strobe “Under”, and the indexes 4 and the indexes 6 of the images, whose index 4 is greater than 0.5, are plotted.

The judging map is employed for evaluating the reliability of the index. As shown in FIG. 19(a) and FIG. 19(b), the judging map is constituted by: each of fundamental areas, including the forward lighting, the backward lighting, the strobe “Over” lighting and the strobe “Under” lighting; the low accurate area (1), which is an intermediate area between the backward lighting and the forward lighting; and the low accurate area (2), which is an intermediate area between the strobe “Over” lighting and the strobe “Under” lighting. Further, as shown in FIG. 19(c), a case in which the index 6 is equal to or greater than zero is defined as “Over”, while another case in which the index 6 is smaller than zero is defined as “Under”. In this connection, although it is applicable that an area being an intermediate area between the backward lighting and the strobe lighting, and/or another area, whose index 6, being an intermediate area between “Over” and “Under”, is in the vicinity of zero, are established as the low accurate area in the judging map, these are omitted in the present embodiment.

Table 7 indicates judging contents of the image capturing conditions according to the graph plotted with each of index values shown in FIG. 18 and the judging map shown in FIG. 19(a) and FIG. 19(b).

TABLE 7

| | Image capturing | | | |
|---|---|---|---|---|
| Region | condition | Index 4 = I₁ | Index 5 = I₂ | Index 6 = I₃ |
| Fundamental | Forward lighting | 0.5 ≧ I₁ | −0.5 ≧ I₂ | — |
| region | | | | |
| Fundamental | Backward lighting | 0.5 ≧ I₁ | I₂ > 1.5 | — |
| region | | | | |
| Fundamental | Strobe “Over” | I₁ > 0.5 | — | I₃ > 1.5 |
| region | lighting | | | |
| Fundamental | Strobe “Under” | I₁ > 0.5 | — | −0.5 ≧ I₃ |
| region | lighting | | | |
| low accurate | Between Forward | 0.5 ≧ I₁ | 1.5 ≧ I₂ > −0.5 | — |
| area (1) | and Backward | | | |
| low accurate | Between Strobe | I₁ > 0.5 | — | 1.5 ≧ I₃ > −0.5 |
| area (2) | “Over” and Strobe | | | |
| | “Under” | | | |

As shown in the above, it is possible not only to quantitatively judge the light source condition by using the values of index 4 and index 5, but also to quantitatively judge the exposure condition by using the values of index 4 and index 6. Further, it is also possible not only to judge the low accurate area (1) being an intermediate area between the forward lighting and the backward lighting by using the values of index 4 and index 5, but also to judge low accurate area (2) being an intermediate area between the strobe “Over” lighting and the strobe “Under” lighting by using the values of index 4 and index 6.

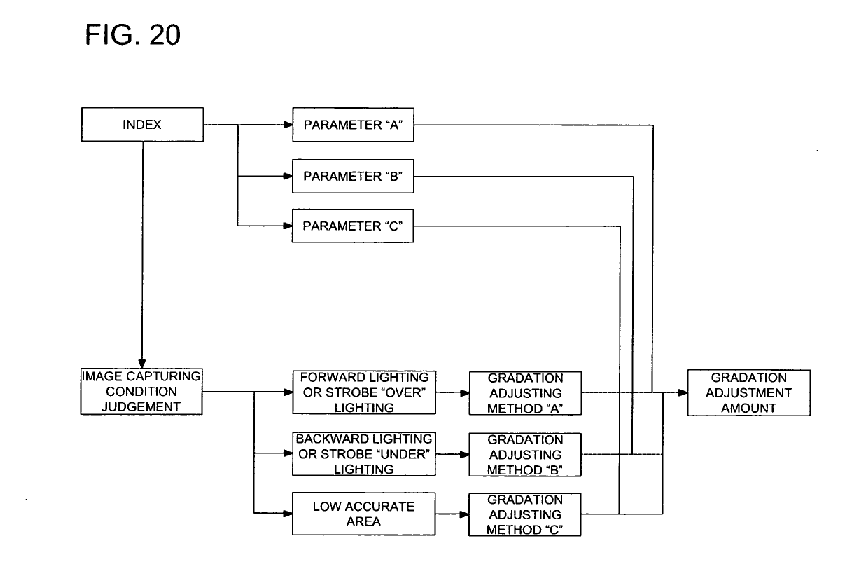

When the image capturing condition is determined, corresponding to the determined image capturing condition, the gradation adjusting method to be employed for the captured image data is selected (determined) (Step S32). As shown in FIG. 20, when the image capturing condition is the forward lighting or the strobe “Over” lighting, the gradation adjusting method “A” (shown in FIG. 21(a)) is selected, while, when the image capturing condition is the backward lighting or the strobe “Under” lighting, the gradation adjusting method “B” (shown in FIG. 21(b)) is selected. Further, when the image capturing condition is the intermediate area between the forward lighting and the backward lighting or the other intermediate area between the strobe “Over” lighting and the strobe “Under” lighting (namely, when the image capturing condition is the low accurate area on the judging map), the gradation adjusting method “C” (shown in FIG. 21(c)) is selected.

As mentioned in the above, since the correction amount is relatively small when the image capturing condition is the forward lighting, it is preferable to employ the gradation adjusting method “A” in which the parallel shifting (offsetting) correction is applied to the pixel values of the captured image data, from the viewpoint that gamma fluctuation can be suppressed. Further, since the correction amount is relatively large when the image capturing condition is the backward lighting or the strobe “Under” lighting, the application of the gradation adjusting method “A” would result in a white muddiness change of black solid color or a brightness lowering of white color, due to an excessive gradation increase of the area at which the image data do not exist. Accordingly, when the image capturing condition is the backward lighting or the strobe “Under” lighting, it is preferable to employ the gradation adjusting method “B” in which the gamma correction is applied to the pixel values of the captured image data. Still further, when the image capturing condition is in the low accurate area on the judging map, since either gradation adjusting method “A” or the gradation adjusting method “B” is employed for one of image capturing conditions being adjacent to each other in every low accurate area, it is preferable to employ the gradation adjusting method “C”, which is a mixture of the gradation adjusting method “A” and the gradation adjusting method “B”. By establishing the low accurate area as mentioned in the above, it becomes possible to smoothly shift the processing result, even when the different gradation adjusting methods are employed. Further, it becomes possible to alleviate occurrences of density variations between plural photographic prints, which are acquired by photographing a same subject. In this connection, although the gradation conversion curve shown in FIG. 21(b) is formed in a convex shape in an upward direction, sometimes, it may be formed in a concave shape in a downward direction. Still further, although the gradation conversion curve shown in FIG. 21(c) is formed in a concave shape in a downward direction, sometimes, it may be formed in a convex shape in an upward direction.

When the gradation adjusting method is determined, the parameters necessary for the gradation adjusting operation (gradation adjusting parameters) are calculated on the basis of the indexes calculated by the index calculating section 713, and then, the gradation conversion condition calculation processing for calculating the gradation conversion condition (gradation adjusting amount) is conducted on the basis of the gradation adjusting parameters calculated in the above (Step S33), and the gradation conversion condition determining processing is finalized. The method for calculating the gradation adjusting parameters and the gradation conversion condition (gradation adjusting amount), to be calculated in Step S33, will be detailed in the following. In this connection, in the following, it is assumed that the 8-bits captured image data is converted to that of 16-bits beforehand, and therefore, the unit of the value of captured image data is 16-bits.

In Step S33, parameters P1-P5 shown as follows are calculated as the gradation adjusting parameters.
P1: average luminance of all over the captured image
P2: block divided average luminance
P3: “luminance correction value 1”=P1-P2
P4: “reproduction target correction value”=“luminance reproduction target value (30360)”−P3
P5: “luminance correction value 2”=(“index 4”/6)×17500

Further, in Step S33, corresponding to the image capturing condition determined in the above, the gradation adjusting amounts (gradation adjusting amounts 1-8) are calculated. Table 8 indicates the gradation adjusting amounts for each of the various image capturing conditions. As shown in Table 8, in the present embodiment, the gradation adjusting amounts 1-5 are defined as primary calculation values, the gradation adjusting amounts 6-8 are defined as secondary calculation values and sums of the primary calculation values and the secondary calculation values are defined as final gradation adjusting amounts (namely, gradation adjusting amounts to be applied to the actual gradation conversion processing). The method for calculating the gradation adjusting amounts 3-8 will be detailed later.

TABLE 8

| | | | Final |
|---|---|---|---|
| Image | Primary | Secondary | gradation |
| capturing | calculation | calculation | adjusting |
| condition | value | value | amount |
| Forward | Gradation | Gradation | Gradation |
| lighting | adjusting | adjusting | adjusting |
| | amount 1 = P4 − P1 | amount 6 | amount 1 + |
| | | | Gradation |
| | | | adjusting |
| | | | amount 6 |
| Strobe “Over” | Gradation | — | Gradation |
| lighting | adjusting | | adjusting |
| | amount 2 = P4 − P5 − P1 | | amount 2 |
| Low accurate | Gradation | Gradation | Gradation |
| area (1) | adjusting | adjusting | adjusting |
| | amount 3 | amount 7 | amount 3 + |
| | | | Gradation |
| | | | adjusting |
| | | | amount 7 |
| Low accurate | Gradation | — | Gradation |
| area (2) | adjusting | | adjusting |
| | amount 3 | | amount 3 |
| Backward | Gradation | Gradation | Gradation |
| lighting | adjusting | adjusting | adjusting |
| | amount 4 | amount 8 | amount 4 + |
| | | | Gradation |
| | | | adjusting |
| | | | amount 8 |
| Strobe | Gradation | — | Gradation |
| “Under” | adjusting | | adjusting |
| lighting | amount 5 | | amount 5 |

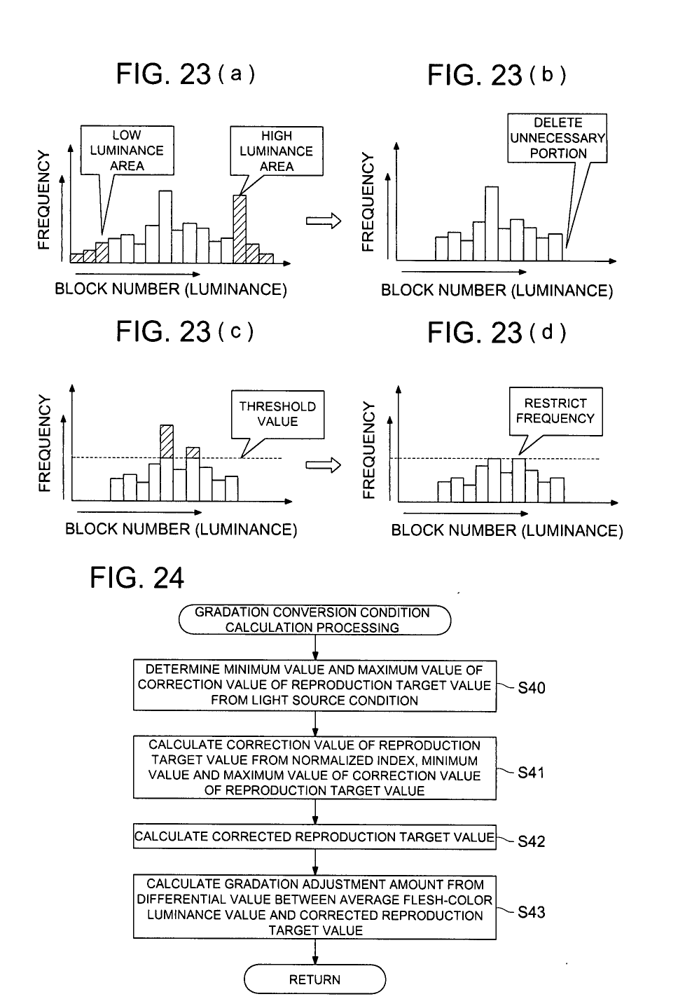

Now, referring to FIG. 22 and FIG. 23, the method for calculating parameter P2 will be detailed in the following.

At first, in order to normalize the captured image data, a CDF (Cumulative Density Function) is created. Successively, maximum values and minimum values are determined from the CDF created. The maximum values and the minimum values are found for every RGB. Hereinafter, the maximum values and the minimum values, found for every RGB in the above, are defined as Rmax, Rmin, Gmax, Gmin, Bmax, Bmin, respectively.

Successively, normalized image data corresponding to an arbitral pixel (Rx, Gx, Bx) are calculated. Establishing that normalized data of Rx in the R plane, normalized data of Gx in the G plane and normalized data of Bx in the B plane, are Rₚₒᵢₙₜ, Gₚₒᵢₙₜ and Bₚₒᵢₙₜ, respectively, the normalized data Rₚₒᵢₙₜ, Gₚₒᵢₙₜ and Bₚₒᵢₙₜ are respectively expressed by Equations (14)-(16) shown as follows.

Rₚₒᵢₙₜ={(Rx−Rmin)/(Rmax−Rmin)}×65535 (14)

Gₚₒᵢₙₜ={(Gx−Gmin)/(Gmax−Gmin)}×65535 (15)

Bₚₒᵢₙₜ={(Bx−Bmin)/(Bmax−Bmin)}×65535 (16)

Still successively, a luminance Nₚₒᵢₙₜ of the pixel (Rx, Gx, Bx) is calculated by employing Equation (17) shown as follow.

Nₚₒᵢₙₜ=(Rₚₒᵢₙₜ+Gₚₒᵢₙₜ+Bₚₒᵢₙₜ)/3 (17)

FIG. 22(a) shows a luminance histogram of the RGB pixel before applying the normalization processing. In FIG. 22(a), the horizontal axis represents luminance, while the vertical axis represents frequency of the pixel. This histogram is created for every RGB. After the histogram is created, the normalizing operations for the captured image data are conducted for every plane by employing Equations (14)-(16). FIG. 22(b) shows a luminance histogram calculated by employing Equation (17). Since the captured image data is normalized by 65535, each of the pixels is set at an arbitral value in a range of 65535 (maximum value) to 0 (minimum value).

A frequency distribution shown in FIG. 22(c) can be obtained by dividing the luminance histogram shown in FIG. 22(b) with a predetermined range. In FIG. 22(c), the horizontal axis represents block number (luminance), while vertical axis represents frequency.

Still successively, the processing for deleting a highlight area and a shadow area form the luminance histogram will be conducted. This is because, since the average luminance becomes very high in the scene including a white wall or a snow background, while the average luminance becomes very low in the darkish scene, the highlight area and the shadow area adversely influence the average luminance controlling operation. Accordingly, by restricting the highlight area and the shadow area included in the luminance histogram shown in FIG. 22(c), the influence power of the both areas can be made to decrease. Concretely speaking, by deleting the high luminance area (highlight area) and the low luminance area (shadow area) from the luminance histogram shown in FIG. 23(a) (or FIG. 22(c)), the histogram shown in FIG. 23(b) can be obtained.

Yet successively, as shown in FIG. 23(c), an area, in which the frequency value exceeds a predetermined threshold value, is deleted from the luminance histogram. This is because, since the data of the partial area, in which the frequency is extremely high, strongly influence the average luminance of all over the captured image, an erroneous correction is liable to occur. Accordingly, in the luminance histogram as shown in FIG. 23(c), the number of pixels, which exceed the predetermined threshold value, is restricted. FIG. 23(d) shows a luminance histogram acquired after the restricting operation of the number of pixels is completed.

The parameter P2 is derived by calculating the luminance average value, based on each block number and its frequency value in the luminance histogram (FIG. 23(d)) acquired by deleting the high luminance area and the low luminance area from the normalized luminance histogram, and father, by restricting the cumulative number of pixels.

Next, the method of calculating the gradation adjusting amount 3 to be calculated when the image capturing condition corresponds to the low accurate area (1) or low accurate area (2) on the judging map, will be detailed in the following.

At first, among the indexes in the low accurate area concerned, a reference index is determined. For instance, with respect to the low accurate area (1), the index 5 is determined as the reference index, while, with respect to the low accurate area (2), the index 6 is determined as the reference index. Then, by normalizing the value of the reference index in a range of 0-1, the concerned reference index is converted to the normalized index. The normalized index is defined as Equation (18) shown as follow.

“normalized index”=(“reference index”−“index minimum value”)/(“index maximum value”−“index minimum value”) (18)

In Equation (18), the index maximum value and the index minimum value are a maximum value and a minimum value of the reference index in the low accurate area concerned, respectively.

Establishing that the correction amounts at the border between two areas of the low accurate area concerned and another area adjacent to the low accurate area concerned, are α and β, respectively, the correction amounts α and β are the fixed values calculated in advance by employing the reproduction target values defined at the border between the areas on the judging map. By using the normalized index defined by Equation (18) and the correction amounts α and β, the gradation adjusting amount 3 is defined as Equation (19) shown as follow.

“gradation adjusting amount 3”=(β−α)×“normalized index”+α (19)

In this connection, although the correlation between the normalized index and the correction amount is established as the first order linear relationship in the present embodiment, it is also applicable that the curvature relationship is employed for this purpose, in order to shift the correction amount more gradually.

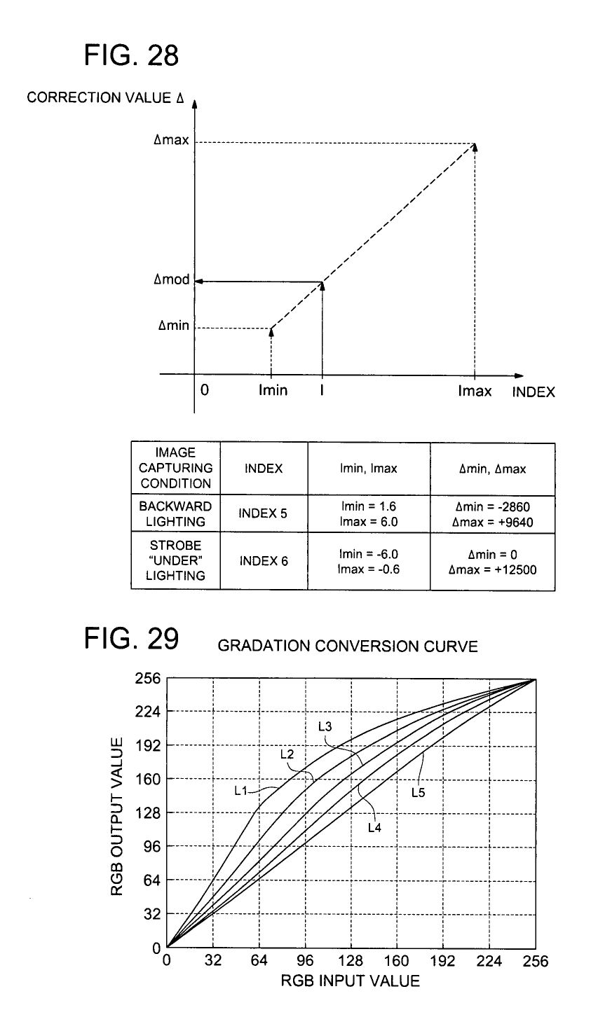

Further, the index to be employed in each of the gradation conversion condition calculation processing described in the following, and, a minimum value Imin and a maximum value Imax of the index concerned are established in advance corresponding to the image capturing condition (refer to FIG. 28). When the image capturing condition is the backward lighting, the index 5 is employed, while, when the image capturing condition is the strobe “Under” lighting, the index 6 is employed. Still further, a minimum value Δmin and a maximum value Δmax of a correction value Δ of each of the parameters to be employed in each of the gradation conversion condition calculation processing (such as, a reproduction target value of the average flesh-color luminance, an average flesh-color luminance value, a reproduction target value-average flesh-color luminance value, etc.) are also established in advance corresponding to the image capturing condition. As shown in FIG. 28, the minimum value Δmin of the correction value Δ is a correction value corresponding to the minimum value Imin of the index concerned, while the maximum value Δmax of the correction value Δ is a correction value corresponding to the maximum value Imax of the index concerned. It is preferable that the differential value (Δmax−Δmin) between this maximum value Δmax and the minimum value Δmin is at least 35 in the 8-bits value.

### Embodiment 1

Referring to the flowchart shown in FIG. 24, the gradation conversion condition calculation processing to be employed in the embodiment 1 will be detailed in the following. In the embodiment 1, the processing for calculating the gradation conversion condition (gradation adjustment amount) when the reproduction target value of the average flesh-color luminance is to be corrected, will be detailed.

At first, based on the light source condition determined in Step S31 shown in FIG. 17, the minimum value Δmin and the maximum value Δmax of the correction value Δ of the reproduction target value are determined (Step S40). Successively, the normalized index is calculated, and then, the correction value Δmod of the reproduction target value is calculated from this normalized index, the minimum value Δmin and the maximum value Δmax of the correction value Δ of the reproduction target value (Step S41). In this connection, establishing that the index calculated in the index calculation processing shown in FIG. 6 (index 5 in the case of the backward lighting, index 6 in the case of the strobe “Under” lighting) is “I”, the normalized index is expressed by Equation (20) shown as follow.

“normalized index”=(I−Imin)/(Imax−Imin) (20)

Further, the correction value Δmod of the reproduction target value calculated in Step S41 is expressed by Equation (21) shown as follow.

“correction value Δmod”=(Δmax−Δmin)×“normalized index”+Δmin (21)

The correction value Δmod calculated in the above corresponds to the index I calculated in the index calculation processing.

Still successively, the corrected reproduction target value is calculated from the reproduction target value and its correction value Δmod by employing Equation (22) shown as follow (Step S42).

“corrected reproduction target value”=“reproduction target value”+Δmod (22)

Still successively, the gradation adjustment amount (gradation adjustment amount 4 or 5) is calculated from the differential value between the average flesh-color luminance value and the corrected reproduction target value, which is calculated in Step S30 shown in FIG. 17, by employing Equation (23) shown as follow (Step S43).

“gradation adjustment amount”=“average flesh-color luminance value”−“corrected reproduction target value” (23)

Then, the gradation conversion condition calculation processing of embodiment 1 is finalized.

For instance, it is assumed that the reproduction target value of the average flesh-color luminance is set at 30360 (16-bits), and the average flesh-color luminance value is set at 21500 (16-bits). Further, it is also assumed that the image capturing condition is determined as the backward lighting, and the value of index 5 calculated in the index calculation processing is 2.7. Under the abovementioned condition, the normalized index, the correction value Δmod, the corrected reproduction target value and the gradation adjustment amount 4 are found as follows.

“normalized index”=(2.7−1.6)/(6.0−1.6)=0.25

Δmod=(9640+2860)×0.25−2860=265

“corrected reproduction target value”=30360+265=30625

“gradation adjustment amount 4”=21500−30625=−9125

### Embodiment 2

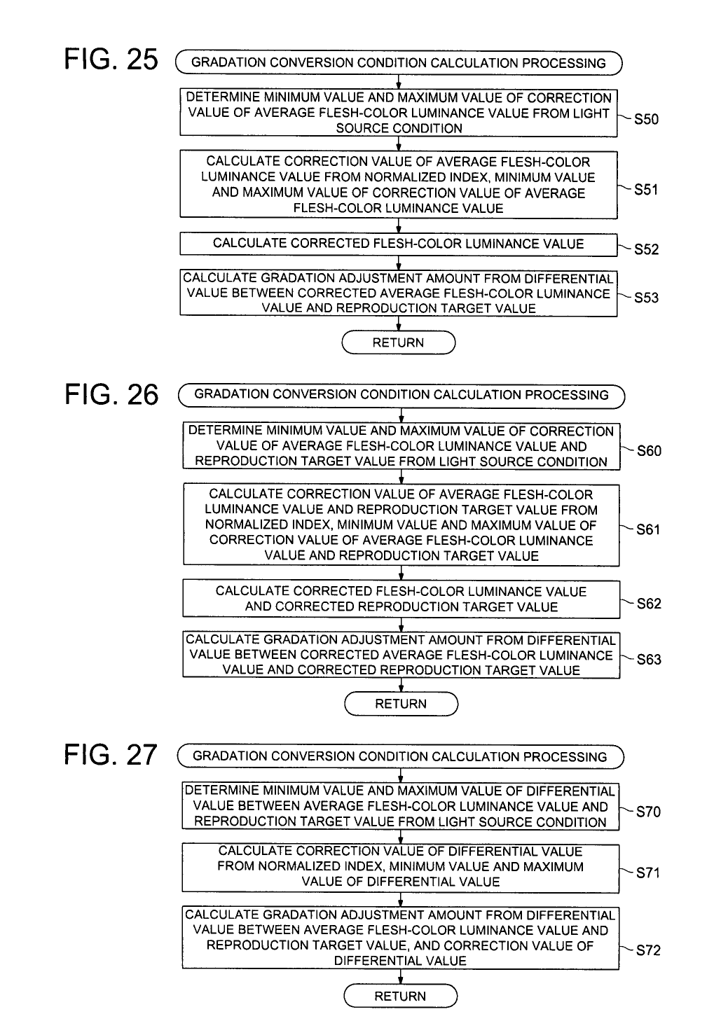

Referring to the flowchart shown in FIG. 25, the gradation conversion condition calculation processing to be employed in the embodiment 2 will be detailed in the following. In the embodiment 2, the processing for calculating the gradation adjustment amount when the average flesh-color luminance value is to be corrected, will be detailed.

At first, based on the light source condition determined in Step S31 shown in FIG. 17, the minimum value Δmin and the maximum value Δmax of the correction value Δ of the average flesh-color luminance value, calculated in Step S30 shown in FIG. 17, are determined (Step S50). Successively, the normalized index is calculated by employing Equation (20), and then, the correction value Δmod of the average flesh-color luminance value is calculated from this normalized index, the minimum value Δmin and the maximum value Δmax of the correction value Δ of the average flesh-color luminance value by employing Equation (24) shown as follow (Step S51).

“correction value Δmod”=(Δmax−Δmin)×“normalized index”+Δmin (24)

As shown in FIG. 28, the correction value Δmod calculated in the above corresponds to the index I calculated in the index calculation processing.

Still successively, the corrected average flesh-color luminance value is calculated from the average flesh-color luminance value and its correction value Δmod by employing Equation (25) shown as follow (Step S52).

“corrected average flesh-color luminance value”=“average flesh-color luminance value”+Δmod (25)

Still successively, the gradation adjustment amount (gradation adjustment amount 4 or 5) is calculated from the differential value between the corrected average flesh-color luminance value and the reproduction target value by employing Equation (26) shown as follow (Step S53).

“gradation adjustment amount”=“corrected average flesh-color luminance value”−“reproduction target value” (26)

Then, the gradation conversion condition calculation processing of embodiment 2 is finalized.

### Embodiment 3

Referring to the flowchart shown in FIG. 26, the gradation conversion condition calculation processing to be employed in the embodiment 3 will be detailed in the following. In the embodiment 3, the processing for calculating the gradation adjustment amount when both the average flesh-color luminance value and the reproduction target value are to be corrected, will be detailed.

At first, based on the light source condition determined in Step S31 shown in FIG. 17, the minimum value Δmin and the maximum value Δmax of the correction value Δ of the average flesh-color luminance value and the reproduction target value, calculated in Step S30 shown in FIG. 17, are determined (Step S60). In this connection, the minimum value and the maximum value of the correction value of the average flesh-color luminance value are the same as the minimum value and the maximum value of the correction value of the reproduction target value, respectively.

Successively, the normalized index is calculated by employing Equation (20), and then, the correction value Δmod of the average flesh-color luminance value and the reproduction target value is calculated from this normalized index, the minimum value Δmin and the maximum value Δmax of the correction value Δ of the average flesh-color luminance value and the reproduction target value by employing Equation (27) shown as follow (Step S61).

“correction value Δmod”=(Δmax−Δmin)×“normalized index”+Δmin (27)

As shown in FIG. 28, the correction value Δmod calculated in the above corresponds to the index I calculated in the index calculation processing.

Still successively, the corrected average flesh-color luminance value and the corrected reproduction target value are calculated from the correction value Δmod calculated by employing Equation (27), the average flesh-color luminance value and the reproduction target value, by employing Equation (28-1) and Equation (28-2) shown as follows (Step S62).

“corrected average flesh-color luminance value”=“average flesh-color luminance value”−Δmod×0.5 (28-1)

“corrected reproduction target value”=“reproduction target value”+Δmod×0.5 (28-2)

In this connection, in such the case that the parameters of both the average flesh-color luminance value and the reproduction target value are to be corrected as described in this embodiment 3, it is assumed that the synthesizing ratio of each of the parameters are determined in advance. Equation (28-1) and Equation (28-2) are established when the synthesizing ratios of both of the average flesh-color luminance value and the reproduction target value are set at 0.5 in advance.

Still successively, the gradation adjustment amount (gradation adjustment amount 4 or 5) is calculated from the differential value between the corrected average flesh-color luminance value and the corrected reproduction target value by employing Equation (27) shown as follow (Step S63).

“gradation adjustment amount”=“corrected average flesh-color luminance value”−“corrected reproduction target value” (27)

Then, the gradation conversion condition calculation processing of embodiment 3 is finalized.

### Embodiment 4

Referring to the flowchart shown in FIG. 27, the gradation conversion condition calculation processing to be employed in the embodiment 4 will be detailed in the following. In the embodiment 4, the processing for calculating the gradation adjustment amount when the differential value between the average flesh-color luminance value and the reproduction target value are to be corrected, will be detailed.

At first, based on the light source condition determined in Step S31 shown in FIG. 17, the minimum value Δmin and the maximum value Δmax of the correction value Δ of the differential value between the average flesh-color luminance value and the reproduction target value (“average flesh-color luminance value”−“reproduction target value”), calculated in Step S30 shown in FIG. 17, are determined (Step S70).

Successively, the normalized index is calculated by employing Equation (20), and then, the correction value Δmod of the concerned differential value from this normalized index, the minimum value Δmin and the maximum value Δmax of the correction value Δ of the differential value (“average flesh-color luminance value”−“reproduction target value”), calculated in Step S30 shown in FIG. 17, by employing Equation (30) shown as follow (Step S71).

“correction value Δmod”=(Δmax−Δmin)×“normalized index”+Δmin (27)

As shown in FIG. 28, the correction value Δmod calculated in the above corresponds to the index I calculated in the index calculation processing.

Still successively, the gradation adjustment amount (gradation adjustment amount 4 or 5) is calculated from the correction value Δmod calculated by employing Equation (30) and the differential value (“average flesh-color luminance value”−“reproduction target value”), by employing Equation (31) shown as follow (Step S72).

“gradation adjustment amount”=“average flesh-color luminance value”−“reproduction target value”−Δmod (31)

Then, the gradation conversion condition calculation processing of embodiment 4 is finalized.

Next, the method for calculating the gradation adjustment amount (each of gradation adjustment amounts 6-8), which is calculated as the secondary calculation value when the light source condition is any one of the forward lighting, the low accurate area (1) and the backward lighting, will be detailed in the following.

The gradation adjustment amount (each of gradation adjustment amounts 6-8) is calculated on the basis of the exposure condition (“Under” or “Over”) determined in Step S31 shown in FIG. 17. When the “index 6”<0 (“Under”), the gradation adjustment amount (each of gradation adjustment amounts 6-8) is defined as Equation (32), while, when the “index 6”≧0 (“Over”), the gradation adjustment amount is defined as Equation (33), shown as follows.
<“index 6”<0 (“Under”)>

“gradation adjustment amount”=(“average flesh-color luminance value”−“reproduction target value”)×“normalized index” (32)

Wherein, according to the Equation (20), the normalized index of Equation (32) can be found as follow;

“normalized index”={“index 6”−(−6)}/{0−(−6)}
<“index 6”≧0 (“Over”)>

“gradation adjustment amount”=(“overall average luminance value”−“reproduction target value”)×“normalized index” (33)

Wherein, according to the Equation (20), the normalized index of Equation (33) can be found as follow;

“normalized index”={“index 6”−0}/(6−0)

The reproduction target value employed in Equation (32) and Equation (33) is such a value that indicates how much extent the brightness of the captured image data, currently being a correction object, should be corrected so as to make it optimum. Table 9 indicates examples of the reproduction target values to be employed in Equation (32) and Equation (33). The reproduction target values indicated in Table 9 are 16-bits values. As shown in Table 9, the reproduction target values are established for every light source condition and for every exposure condition. According to Equation (32) and Equation (33), the gradation adjustment amount 6 is calculated when the light source condition is the forward lighting, the gradation adjustment amount 7 is calculated when the light source condition is the low accurate area (1), while the gradation adjustment amount 8 is calculated when the light source condition is the backward lighting.

TABLE 9
[reproduction target value]

| | “Under” | “Over” |
|---|---|---|
| Forward lighting | 4000 | 15000 |
| Backward lighting • low accurate | 5000 | 10000 |
| area (1) | | |

When the calculating operation of the gradation adjustment amounts (gradation adjustment amounts 1-8) are completed, a gradation conversion curve corresponding to the gradation adjustment amount calculated in the gradation conversion condition calculation processing is selected (determined) from a plurality of gradation conversion curves established in advance according to the gradation adjustment method determined in Step S32 shown in FIG. 17. Alternatively, it is also applicable that the gradation conversion curve is calculated on the basis of the gradation adjustment amounts calculated in the above. When the gradation conversion curve is determined, the gradation conversion processing is applied to the captured image data according to the gradation conversion curve determined in the above.

The method for determining the gradation conversion curve in regard to each of the image capturing conditions will be detailed in the following.

### <In Case of Forward Lighting>

When the image capturing condition is the forward lighting, the offset correction for matching the parameters P1 and P4 with each other (parallel shifting operation of 8-bits value) is conducted by employing Equation (34) shown as follow.

“RGB values of output image”=“RGB values of input image”+“gradation adjustment amount 1”+“gradation adjustment amount 6” (34)

Accordingly, when the image capturing condition is the forward lighting, the gradation conversion curve corresponding to Equation (34) is selected from the plurality of gradation conversion curves shown in FIG. 21(a). Alternatively, it is also applicable to calculate (determine) the gradation conversion curve based on Equation (34).

### <In Case of Backward Lighting>

When the image capturing condition is the backward lighting, a key correction value Q is calculated from the gradation adjustment amount 4 calculated in the gradation conversion condition calculation processing performed in any one of embodiments 1-4 by employing Equation (35) shown as follow. Then, the gradation conversion curve corresponding to the key correction value Q found by Equation (35) is selected from the plurality of gradation conversion curves shown in FIG. 21(b).

“key correction value Q”=(“gradation adjustment amount 4”+“gradation adjustment amount 8”)/“key correction coefficient” (35)

where the value of the key correction coefficient to be employed in Equation (35) is 24.78. FIG. 29 shows concrete examples of the gradation conversion curves shown in FIG. 21(b). The correlation relationship between the value of the key correction value Q and the gradation conversion curve to be selected in FIG. 29 is indicated as follows.

When −50<Q<+50,→L3;

when +50≦Q<+150,→L4;

when +150≦Q,→L5;

when −150<Q≦−50,→L2; and

when Q≦−150,→L1.

In this connection, when the image capturing condition is the backward lighting, it is preferable that the dodging is also applied in addition to this gradation conversion processing. In this case, it is desirable that the degree of dodging is also adjusted corresponding to the index 5 representing the degree of the backward lighting.

### <In Case of Strobe “Under” Lighting>

When the image capturing condition is the strobe “Under” lighting, a key correction value Q′ is calculated from the gradation adjustment amount 5 calculated in the gradation conversion condition calculation processing performed in any one of embodiments 1-4 by employing Equation (36) shown as follow. Then, the gradation conversion curve corresponding to the key correction value Q′ found by Equation (36) is selected from the plurality of gradation conversion curves shown in FIG. 21(b).

“key correction value Q′”=“gradation adjustment amount 5”/“key correction coefficient” (36)

where the value of the key correction coefficient to be employed in Equation (36) is 24.78. The correlation relationship between the value of the key correction value Q′ and the gradation conversion curve to be selected in FIG. 29, which shows concrete examples of them shown in FIG. 21(b), is indicated as follows.

When −50<Q′<+50,→L3;

when +50≦Q′<+150,→L4;

when +150≦Q′,→L5;

when −150<Q′≦−50,→L2; and

when Q′≦−150,→L1.

In this connection, when the image capturing condition is the strobe “Under” lighting, such the dodging processing that is indicated in the case of the backward lighting, is not applied.

### <In Case of Strobe “Over” Lighting>

When the image capturing condition is the strobe “Over” lighting, the offset correction (parallel shifting operation of 8-bits value) is conducted by employing Equation (37) shown as follow.

“RGB values of output image”=“RGB values of input image”+“gradation adjustment amount 2” (37)

Accordingly, when the image capturing condition is the strobe “Over” lighting, the gradation conversion curve corresponding to Equation (37) is selected from the plurality of gradation conversion curves shown in FIG. 21(a). Alternatively, it is also applicable to calculate (determine) the gradation conversion curve based on Equation (37).

### <In Case of Low Accurate Area (1)>

When the image capturing condition is the low accurate area (1), the offset correction (parallel shifting operation of 8-bits value) is conducted by employing Equation (38) shown as follow.

“RGB values of output image”=“RGB values of input image”+“gradation adjustment amount 3”+“gradation adjustment amount 7” (38)

Accordingly, when the image capturing condition is the low accurate area (1), the gradation conversion curve corresponding to Equation (38) is selected from the plurality of gradation conversion curves shown in FIG. 21(c). Alternatively, it is also applicable to calculate (determine) the gradation conversion curve based on Equation (38).

### <In Case of Low Accurate Area (2)>

When the image capturing condition is the low accurate area (2), the offset correction (parallel shifting operation of 8-bits value) is conducted by employing Equation (39) shown as follow.

“RGB values of output image”=“RGB values of input image”+“gradation adjustment amount 3” (39)

Accordingly, when the image capturing condition is the low accurate area (2), the gradation conversion curve corresponding to Equation (39) is selected from the plurality of gradation conversion curves shown in FIG. 21(c). Alternatively, it is also applicable to calculate (determine) the gradation conversion curve based on Equation (39).

In this connection, in the present embodiment, when the gradation conversion is actually applied to the captured image data, each of the gradation conversion condition aforementioned is converted from 16-bits to 8-bits.

As described in the foregoing, according to the image processing apparatus 1 of the present embodiment, it becomes possible to conduct such the image processing that continuously and appropriately compensates for (corrects) an excessiveness or shortage of light amount in the flesh-color area, caused by both the light source condition and the exposure condition.

Specifically, by applying the gradation conversion processing to the captured image data, while employing not only the gradation conversion conditions (gradation conversion conditions 1-5), which are calculated by employing the indexes representing the light source condition, but also the other gradation conversion conditions (gradation conversion conditions 6-8), which are calculated by employing the index (index 6) representing the exposure condition, it becomes possible to improve a reliability of the correction concerned.

### <Example Employed for Image Capturing Apparatus>

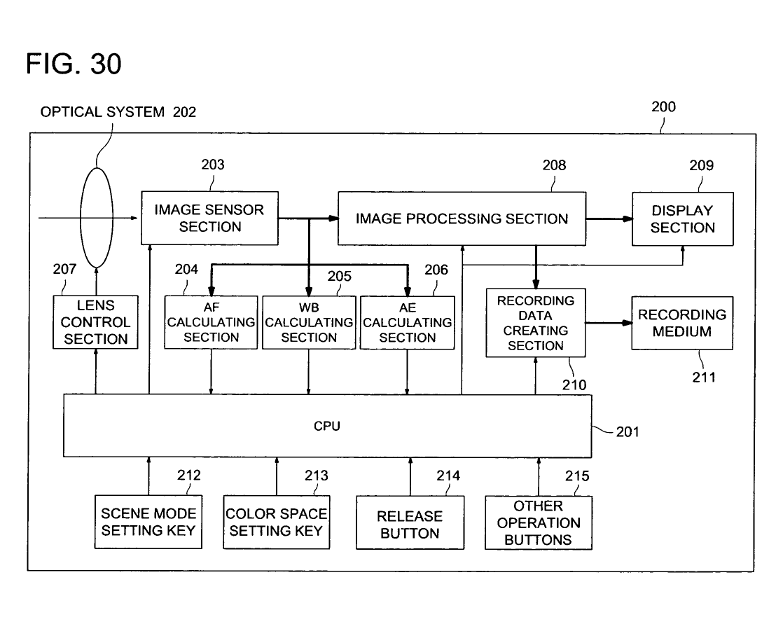

The image processing method indicated in the aforementioned embodiments is applicable to the image capturing apparatus, such as a digital still camera, etc. FIG. 30 shows a configuration of a digital still camera 200, to which the image capturing apparatus embodied in the present invention is applied. As shown in FIG. 30, the digital still camera 200 is constituted by a CPU (Central Processing Unit) 201, an optical system 202, an image sensor section 203, an AF (Auto Focus) calculating section 204, a WB (White Balance) calculating section 205, an AE (Auto Exposure) calculating section 206, a lens control section 207, an image processing section 208, a display section 209, a recording data creating section 210, a recording medium 211, a scene mode setting key 212, a color space setting key 213, a release button 214 and other operation buttons 215.

The AF calculating section 204 calculates distances of AF areas disposed at nine points within an image, and outputs calculated results. The distance judging operation is conducted by using the contrast judging operation of the image, so that the CPU 201 selects a value, existing at the nearest distance therefrom, as a subject distance. The WB calculating section 205 calculates and outputs the white balance evaluation values. The white balance evaluation values are gain values necessary for matching the RGB output values of a neutral subject under the current light source at the time of image capturing operation, and are calculated as ratios R/G, B/G by setting the G channel as reference. The white balance evaluation values, calculated in the above, are inputted into the image processing section 208, so as to adjust the white balance of the image concerned. The AE calculating section 206 calculates an optimum exposure value from the image data, to output the calculated optimum exposure value, and then, the CPU 201 calculates an aperture value and a shutter speed so that the calculated optimum exposure value coincides with the current exposure value. The calculated aperture value is outputted to the lens control section 207, which sets an aperture diameter at a value corresponding to the inputted aperture value. The calculated shutter speed value is outputted to the image sensor section 203, which sets an integration time of the CCD (Charge Coupled Device), corresponding to the inputted shutter speed value.

After various kinds of processing, including the white balance processing, the interpolation processing of the CCD filter alignment, the color conversion processing, the primary gradation conversion processing, the sharpness correction processing, etc., are applied to the captured image data, as well as the aforementioned embodiment, the image processing section 208 calculates the indexes (indexes 1-6) for specifying the image capturing condition, and determines the image capturing condition based on the calculated indexes, and then, conducts the gradation conversion processing based on the results determined in the above, so as to converts the original image to a preferable image. Successively, the image processing section 208 implements the various converting operations, such as the JPEG compression, etc. The processed image data compressed by the JPEG compression are outputted to the display section 209 and the recording data creating section 210.

The display section 209 displays not only the image represented by the captured image data, but also various kinds of information according to the instruction sent from the CPU 201 on the liquid crystal display. The recording data creating section 210 formats the image data compressed by the JPEG compression and various kinds of captured image data inputted from the CPU 201 into the Exif (Exchangeable Image File Format) file, so as to store them into the recording medium 211. Since there is provided a partial area, called a maker note, in some of the recording medium 211, into which each of makers may freely write certain information, it is applicable that the determined results of the image capturing conditions, index 4, index 5 and index 6 are stored in such the partial area.

In the digital still camera 200, it is possible for the user to change the photographing scene mode by using the user setting. Concretely speaking, three modes, including a normal mode, a portrait mode and a landscape scene mode, are provided as the selectable photographing scene modes. When the user operates the scene mode setting key 212 to select the portrait mode in the case that the subject is the human being, or the landscape scene mode in the case that the subject is the landscape scene, the primary gradation conversion processing being appropriate for the subject is implemented in the digital still camera 200. Further, the digital still camera 200 stores the information in regard to the photographing scene mode, selected by the user, by attaching them to the maker note area of the image data file. Still further, the digital still camera 200 stores the positional information of the AF area, selected as the subject, into the image data file, as well as the above.

In this connection, the digital still camera 200 makes the user setting operation of the output color space possible by using the color space setting key 213. Either the sRGB (IEC61966-2-1) or the Raw is selectable as the output color space. When the sRGB is selected, the image processing described in the present embodiment are implemented, while, when the Raw is selected, image data in the color space inherent to the CCD image sensor are outputted, without implementing the image processing described in the present embodiment.

As described in the foregoing, according to the digital still camera 200, to which the image capturing apparatus embodied in the present invention is applied, as well as the image processing apparatus 1 aforementioned, by conducting the steps of: calculating the index quantitatively indicating the image capturing condition of the captured image data; judging the image capturing condition based on the index calculated; determining the gradation adjustment method for the captured image data corresponding to the judged result; and determining the gradation adjustment amount (gradation conversion curve) of the captured image data, it becomes possible to appropriately correct the brightness of the subject. As aforementioned, since the gradation conversion processing appropriately corresponding to the image capturing condition is conducted in the digital still camera 200, it becomes possible to output a preferable image, even if the digital still camera 200 is directly coupled to the printer without coupling the personal computer between them.

Incidentally, the contents of the descriptions in regard to the present embodiment can be varied as needed without departing from the spirit and scope of the invention.

For instance, it is also applicable that the facial image is detected (extracted) from the captured image data, and the image capturing condition is judged and determined on the basis of the detected facial image in order to determine the gradation processing condition. Further, it is also applicable that the Exif information is employed for determining the image capturing condition. By employing the Exif information, it becomes possible to further improve the determining accuracy of the image capturing condition.

1-128. (canceled)

129. An image processing method for calculating a brightness value indicating brightness in a flesh-color area represented by captured image data, so as to correct the brightness value to a reproduction target value determined in advance, the image processing method comprising:
a light source condition index calculating process for calculating an index representing a light source condition of the captured image data;
a correction value calculating process for calculating a correction value of the reproduction target value, corresponding to the index representing the light source condition, calculated in the light source condition index calculating process;
a first gradation conversion condition calculating process for calculating a gradation conversion condition for the captured image data, based on the correction value of the reproduction target value, calculated in the correction value calculating process;
an exposure condition index calculating process for calculating an index representing an exposure condition of the captured image data; and
a second gradation conversion condition calculating process for calculating a gradation conversion condition for the captured image data, corresponding to the index representing the exposure condition, calculated in the exposure condition index calculating process.

130. An image processing method for calculating a brightness value indicating brightness in a flesh-color area represented by captured image data, so as to correct the brightness value to a reproduction target value determined in advance, the image processing method comprising:
a light source condition index calculating process for calculating an index representing a light source condition of the captured image data;
a correction value calculating process for calculating a correction value of the brightness in the flesh-color area, corresponding to the index representing the light source condition, calculated in the light source condition index calculating process;
a first gradation conversion condition calculating process for calculating a gradation conversion condition for the captured image data, based on the correction value of the brightness, calculated in the correction value calculating process;
an exposure condition index calculating process for calculating an index representing an exposure condition of the captured image data; and
a second gradation conversion condition calculating process for calculating a gradation conversion condition for the captured image data, corresponding to the index representing the exposure condition, calculated in the exposure condition index calculating process.

131. An image processing method for calculating a brightness value indicating brightness in a flesh-color area represented by captured image data, so as to correct the brightness value to a reproduction target value determined in advance, the image processing method comprising:
a light source condition index calculating process for calculating an index representing a light source condition of the captured image data;
a correction value calculating process for calculating a correction value of the reproduction target value and another correction value of the brightness in the flesh-color area, corresponding to the index representing the light source condition, calculated in the light source condition index calculating process;
a first gradation conversion condition calculating process for calculating a gradation conversion condition for the captured image data, based on the correction value of the reproduction target value and the other correction value of the brightness in the flesh-color area, calculated in the correction value calculating process;
an exposure condition index calculating process for calculating an index representing an exposure condition of the captured image data; and
a second gradation conversion condition calculating process for calculating a gradation conversion condition for the captured image data, corresponding to the index representing the exposure condition, calculated in the exposure condition index calculating process.

132. An image processing method for calculating a brightness value indicating brightness in a flesh-color area represented by captured image data, so as to correct the brightness value to a reproduction target value determined in advance, the image processing method comprising:
a light source condition index calculating process for calculating an index representing a light source condition of the captured image data;
a correction value calculating process for calculating a correction value of a differential value between the brightness value indicating the brightness in the flesh-color and the reproduction target value, corresponding to the index representing the light source condition, calculated in the light source condition index calculating process;
a first gradation conversion condition calculating process for calculating a gradation conversion condition for the captured image data, based on the correction value of the differential value, calculated in the correction value calculating process;
an exposure condition index calculating process for calculating an index representing an exposure condition of the captured image data; and
a second gradation conversion condition calculating process for calculating a gradation conversion condition for the captured image data, corresponding to the index representing the exposure condition, calculated in the exposure condition index calculating process.

133. The image processing method of claim 129,
wherein a maximum value and a minimum value of the correction value of the reproduction target value are established in advance, corresponding to the index representing the light source condition.

134. The image processing method of claim 130,
wherein a maximum value and a minimum value of the correction value of the brightness in a flesh-color area are established in advance, corresponding to the index representing the light source condition.

135. The image processing method of claim 132,
wherein a maximum value and a minimum value of the correction value of the differential value between the brightness value indicating the brightness in the flesh-color and the reproduction target value are established in advance, corresponding to the index representing the light source condition.

136. The image processing method of any one of claim 129, further comprising:
a judging process for judging the light source condition of the captured image data, based on the index representing the light source condition calculated in the light source condition index calculating process and a judging map, which is divided into areas corresponding to reliability of the light source condition;
wherein the correction value is calculated, based on a judging result made in the judging process.

137. The image processing method of claims 129, further comprising:
an occupation ratio calculating process for dividing the captured image data into divided areas having combinations of predetermined hue and brightness, and calculating an occupation ratio indicating a ratio of each of the divided areas to a total image area represented by the captured image data is calculated for every area;
wherein, in the light source condition index calculating process, the index representing the light source condition is calculated by multiplying the occupation ratio calculated in the occupation ratio calculating process by a coefficient established in advance corresponding to the light source condition.

138. The image processing method of claims 129, further comprising:
an occupation ratio calculating process for dividing the captured image data into predetermined areas having combinations of distances from an outside edge of an image represented by the captured image data and brightness, and calculating an occupation ratio, indicating a ratio of each of the predetermined areas to a total image area represented by the captured image data, for every divided area concerned;
wherein the index representing the light source condition is calculated by multiplying the occupation ratio calculated in the occupation ratio calculating process by a coefficient established in advance corresponding to the light source condition, in the light source condition index calculating process.

139. The image processing method of any one of claim 129, further comprising:
an occupation ratio calculating process for dividing the captured image data into divided areas having combinations of predetermined hue and brightness, and calculating a first occupation ratio, indicating a ratio of each of the divided areas to a total image area represented by the captured image data, for every divided area concerned, and at the same time, for dividing the captured image data into predetermined areas having combinations of distances from an outside edge of an image represented by the captured image data and brightness, and calculating a second occupation ratio, indicating a ratio of each of the predetermined areas to a total image area represented by the captured image data, for every divided area concerned;
wherein the index representing the light source condition is calculated by multiplying the first occupation ratio and the second occupation ratio calculated in the occupation ratio calculating process by a coefficient established in advance corresponding to the light source condition, in the light source condition index calculating process.

140. The image processing method of claim 129,
wherein, in the second gradation conversion condition calculating process, gradation conversion conditions for the captured image data are calculated, based on the index representing the exposure condition, which is calculated in the exposure condition index calculating process, and a differential value between the brightness value indicating brightness in the flesh-color area and the reproduction target value.

141. The image processing method of claim 129,
wherein, in the second gradation conversion condition calculating process, gradation conversion conditions for the captured image data are calculated, based on the index representing the exposure condition, which is calculated in the exposure condition index calculating process, and a differential value between another brightness value indicating brightness of a total image area represented by the captured image data and the reproduction target value.

142. The image processing method of claim 129, further comprising:
a bias amount calculating process for calculating a bias amount indicating a bias of a gradation distribution of the captured image data;
wherein, in the exposure condition index calculating process, the index representing the exposure condition is calculated by multiplying the bias amount calculated in the bias amount calculating process by a coefficient established in advance corresponding to the exposure condition.

143. The image processing method of claim 142,
wherein the bias amount includes at least any one of a deviation amount of brightness of the captured image data, an average value of brightness at a central position of an image represented by the captured image data, a differential value between brightness calculated under different conditions.

144. The image processing method of claim 138, further comprising:
a process for creating a two dimensional histogram by calculating a cumulative number of pixels for every distance from an outside edge of an image represented by the captured image data, and for every brightness;
wherein, in the occupation ratio calculating process, the occupation ratio is calculated, based on the two dimensional histogram created in the process.

145. The image processing method of claim 139, further comprising:
a process for creating a two dimensional histogram by calculating a cumulative number of pixels for every distance from an outside edge of an image represented by the captured image data, and for every brightness;
wherein, in the occupation ratio calculating process, the second occupation ratio is calculated, based on the two dimensional histogram created in the process.

146. The image processing method of claim 137, further comprising:
a process for creating a two dimensional histogram by calculating a cumulative number of pixels for every predetermined hue and for every predetermined brightness of the captured image data;
wherein, in the occupation ratio calculating process, the occupation ratio is calculated, based on the two dimensional histogram created in the process.

147. The image processing method of claim 139, further includes:
a process for creating a two dimensional histogram by calculating a cumulative number of pixels for every predetermined hue and for every predetermined brightness of the captured image data;
wherein, in the occupation ratio calculating process, the first occupation ratio is calculated, based on the two dimensional histogram created in the process.

148. The image processing method of claim 137,
wherein, in at least any one of the light source condition index calculating process and the exposure condition index calculating process, a sign of the coefficient to be employed in a flesh-color area having high brightness is different from that of the other coefficient to be employed in a hue area other than the flesh-color area having the high brightness.

149. The image processing method of claim 137,
wherein, in at least any one of the light source condition index calculating process and the exposure condition index calculating process, a sign of the coefficient to be employed in a flesh-color area having intermediate brightness is different from that of the other coefficient to be employed in a hue area other than the flesh-color area having the intermediate brightness.

150. The image processing method of claim 148,
wherein a brightness area of the hue area other than the flesh-color area having the high brightness is a predetermined high brightness area.

151. The image processing method of claim 148,
wherein a brightness area other than the intermediate brightness area is a brightness area within the flesh-color area.

152. The image processing method of claim 148,
wherein the hue area other than the flesh-color area having the high brightness includes at least any one of a blue hue area and a green hue area.

153. The image processing method of claim 149,
wherein the hue area other than the flesh-color area having the intermediate brightness is a shadow area.

154. The image processing method of claim 148,
wherein the flesh-color area is divided into two areas by employing a predetermined conditional equation based on brightness and saturation.
